(19) United States
(12) Patent Application Publication
(10) Pub. No.: US 2019/0303549 A1
(43) Pub. Date: Oct. 3, 2019

(54) ELECTRONIC DEVICE, CONTROLLER, AND OPERATION METHOD OF ELECTRONIC DEVICE

(71) Applicant: KYOCERA CORPORATION, Kyoto (JP)

(72) Inventors: Shigeki TANABE, Yokohama-shi (JP); Yasuhiro UENO, Yokohama-shi (JP); Hideki MORITA, Yokohama-shi (JP); Isao MASUIKE, Tokyo (JP); Koutaro YAMAUCHI, Yokohama-shi (JP); Minabu SAKUMA, Yokohama-shi (JP); Kenji SHIMADA, Yokohama-shi (JP)

(21) Appl. No.: 16/365,494

(22) Filed: Mar. 26, 2019

(30) Foreign Application Priority Data
Mar. 28, 2018 (JP) 2018-061904

(51) Int. Cl. G06F 21/32; G06K 9/00; G06F 3/041; G06F 3/044

(52) U.S. Cl. CPC G06F 21/32; G06K 9/0002; G06K 9/0004; G06F 3/044; G06K 9/00087; G06F 3/0414

(57) ABSTRACT

An electronic device, a controller, and an operation method of an electronic device are disclosed. In one embodiment, an electronic device comprises a fingerprint sensor, a pressure detector, and at least one processor. The fingerprint sensor comprises a detecting surface, and is configured to detect a fingerprint of a finger touching the detecting surface. The pressure detector comprises a plurality of pressure sensors configured to detect pressure applied on the detecting surface. The at least one processor is configured to perform processing based on a fingerprint detection result of the fingerprint sensor and a pressure detection result of the pressure detector. The pressure detection result varies depending on a position on the detecting surface at which the pressure is applied.

### CROSS-REFERENCE TO RELATED APPLICATION

The present application claims priority under 35 U.S.C. § 119 to Japanese Patent Application No. 2018-061904, filed on Mar. 28, 2018, entitled “ELECTRONIC DEVICE, CONTROLLER, CONTROL PROGRAM, AND OPERATION METHOD OF ELECTRONIC DEVICE”. The content of which is incorporated by reference herein in its entirety.

### FIELD

Embodiments of the present disclosure relate generally to an electronic device.

### BACKGROUND

Various technologies have been proposed for an electronic device.

### SUMMARY

An electronic device, a controller, and an operation method of an electronic device are disclosed. In one embodiment, an electronic device comprises a fingerprint sensor, a pressure detector, and at least one processor. The fingerprint sensor comprises a detecting surface, and is configured to detect a fingerprint of a finger touching the detecting surface. The pressure detector comprises a plurality of pressure sensors configured to detect pressure applied on the detecting surface. The at least one processor is configured to perform processing based on a fingerprint detection result of the fingerprint sensor and a pressure detection result of the pressure detector. The pressure detection result varies depending on a position on the detecting surface at which the pressure is applied.

In one embodiment, a controller is comprised in an electronic device. The electronic device comprises a fingerprint sensor, and a pressure detector. The fingerprint sensor comprises a detecting surface, and is configured to detect a fingerprint of a finger touching the detecting surface. The pressure detector comprises a plurality of pressure sensors configured to detect pressure applied on the detecting surface. A pressure detection result of the pressure detector varies depending on a position on the detecting surface at which the pressure is applied. The controller is configured to perform processing based on a fingerprint detection result of the fingerprint sensor and the pressure detection result.

In one embodiment, an operation method is an operation method of an electronic device. The electronic device comprises a fingerprint sensor, and a pressure detector. The fingerprint sensor comprises a detecting surface, and is configured to detect a fingerprint of a finger touching the detecting surface. The pressure detector comprises a plurality of pressure sensors configured to detect pressure applied on the detecting surface. A pressure detection result of the pressure detector varies depending on a position on the detecting surface at which the pressure is applied. The operation method comprises performing processing based on a fingerprint detection result of the fingerprint sensor and the pressure detection result.

### BRIEF DESCRIPTION OF THE DRAWINGS

FIG. 1 illustrates a perspective view showing one example of external appearance of an electronic device.

FIG. 2 illustrates a back view showing one example of external appearance of the electronic device.

FIG. 3 illustrates a block diagram showing one example of a configuration of the electronic device.

FIG. 4 illustrates a diagram showing one example of a configuration of the electronic device.

FIG. 5 illustrates a diagram showing one example of a configuration of the electronic device.

FIG. 6 illustrates a diagram showing one example of display of the electronic device.

FIG. 7 illustrates a diagram showing one example of display of the electronic device.

FIG. 8 illustrates a diagram showing one example of display of the electronic device.

FIG. 9 illustrates a flowchart showing one example of operation of the electronic device.

FIG. 10 illustrates a diagram showing one example of display of the electronic device.

FIG. 11 illustrates a diagram showing one example of display of the electronic device.

FIG. 12 illustrates a flowchart showing one example of operation of the electronic device.

FIG. 13 illustrates a diagram showing one example of operation on a detecting surface.

FIG. 14 illustrates a diagram showing one example of operation on the detecting surface.

FIG. 15 illustrates a diagram showing one example of operation on the detecting surface.

FIG. 16 illustrates a diagram showing one example of operation on the detecting surface.

FIG. 17 illustrates a diagram showing one example of operation on the detecting surface.

FIG. 18 illustrates a diagram showing one example of display of the electronic device.

FIG. 19 illustrates a diagram showing one example of operation on a display surface.

FIG. 20 illustrates an explanatory diagram showing one example of operation of the electronic device.

FIG. 21 illustrates a flowchart showing one example of operation of the electronic device.

FIG. 22 illustrates a diagram showing one example of display of the electronic device.

FIG. 23 illustrates a diagram showing one example of display of the electronic device.

FIG. 24 illustrates a diagram showing one example of display of the electronic device.

FIG. 25 illustrates a flowchart showing one example of operation of the electronic device.

FIG. 26 illustrates a diagram showing one example of display of the electronic device.

FIG. 27 illustrates a flowchart showing one example of operation of the electronic device.

FIG. 28 illustrates a diagram showing one example of display of the electronic device.

FIG. 29 illustrates a flowchart showing one example of operation of the electronic device.

FIG. 30 illustrates a diagram showing one example of display of the electronic device.

FIG. 31 illustrates a flowchart showing one example of operation of the electronic device.

FIG. 32 illustrates a flowchart showing one example of operation of the electronic device.

FIG. 33 illustrates a flowchart showing one example of operation of the electronic device.

FIG. 34 illustrates a flowchart showing one example of operation of the electronic device.

FIG. 35 illustrates a diagram showing one example of display of the electronic device.

FIG. 36 illustrates a diagram showing one example of display of the electronic device.

FIG. 37 illustrates a flowchart showing one example of operation of the electronic device.

FIG. 38 illustrates a flowchart showing one example of operation of the electronic device.

FIG. 39 illustrates a diagram showing one example of a configuration of the electronic device.

FIG. 40 illustrates a diagram showing one example of a configuration of the electronic device.

FIG. 41 illustrates a diagram showing one example of a configuration of the electronic device.

### DETAILED DESCRIPTION

<One Example of External Appearance of Electronic Device>

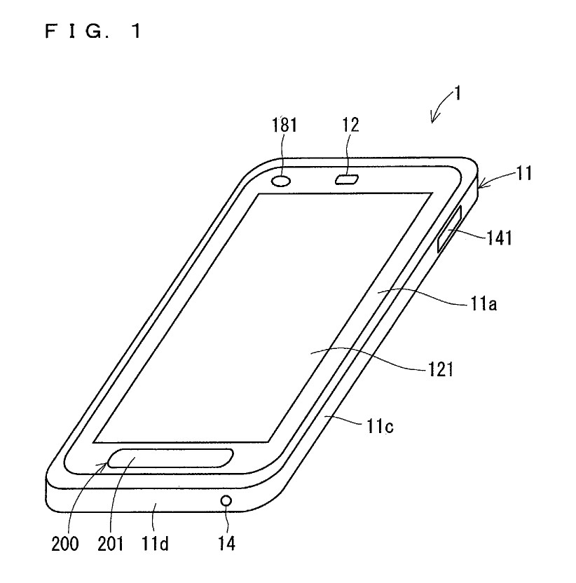

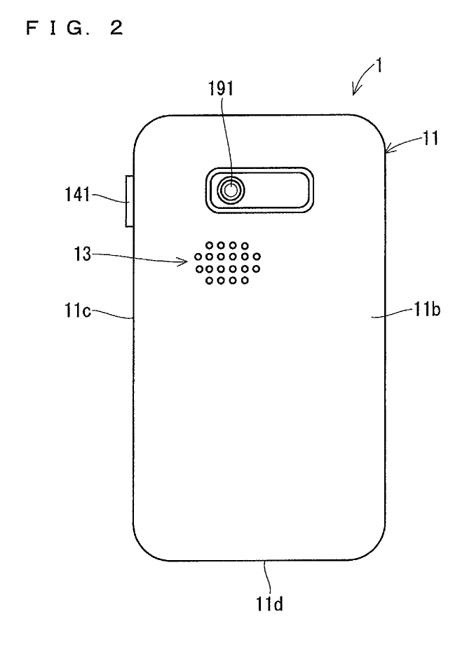

FIG. 1 and FIG. 2 respectively illustrate a perspective view and a back view showing one example of external appearance of an electronic device 1. As illustrated in FIG. 1 and FIG. 2, the electronic device 1 comprises a plate-like device case 11 that has a substantially rectangular shape in plan view. The device case 11 forms an outer case of the electronic device 1.

On a front surface 11a of the device case 11, i.e., on a front surface of the electronic device 1, a display surface 121, on which various pieces of information such as letters, symbols, and graphics are displayed, is disposed. A touch panel 130 (described later) is located on a back surface side of the display surface 121. With this, a user can input various pieces of information into the electronic device 1 by operating the display surface 121 on the front surface of the electronic device 1 with a finger or the like. Note that the user can input various pieces of information into the electronic device 1 also by operating the display surface 121 with a pointer other than a finger, namely, a touch panel pen such as a stylus pen.

A receiver hole 12 is located at an upper end portion of the front surface 11a of the device case 11. A microphone hole 14 is located on a side surface 11d on a lower side of the device case 11. A lens 181 of a first camera 180 (described later) is visibly recognizable from the upper end portion of the front surface 11a of the device case 11. As illustrated in FIG. 2, a lens 191 of a second camera 190 (described later) is visibly recognizable from an upper end portion of a back surface 11b of the device case 11, i.e., a back surface of the electronic device 1. Further, a speaker hole 13 is located on the back surface 11b of the device case 11.

At a lower end portion of the front surface 11a of the device case 11, a detecting surface 201 of a fingerprint sensor 200 is located. It can be said that the detecting surface 201 is exposed from the front surface of the electronic device 1. The fingerprint sensor 200 can detect a fingerprint of a finger touching the detecting surface 201. It can also be said that the detecting surface 201 is a detecting area 201.

The electronic device 1 comprises an operation button group 140 (described later) that is made up of a plurality of operation buttons. Each of the operation buttons is, for example, a hardware button, and is located on the surface of the device case 11. Each of the operation buttons is, for example, a push button. The operation button group 140 comprises a power button 141. The power button 141 is located on a side surface 11c located on a right side of the device case 11. The right side herein refers to a right side when the user looks at the display surface 121. Further, a left side refers to a left side when the user looks at the display surface 121. The operation button group 140 comprises an operation button other than the power button 141. For example, the operation button group 140 may comprise a volume button.

<One Example of Electrical Configuration of Electronic Device>

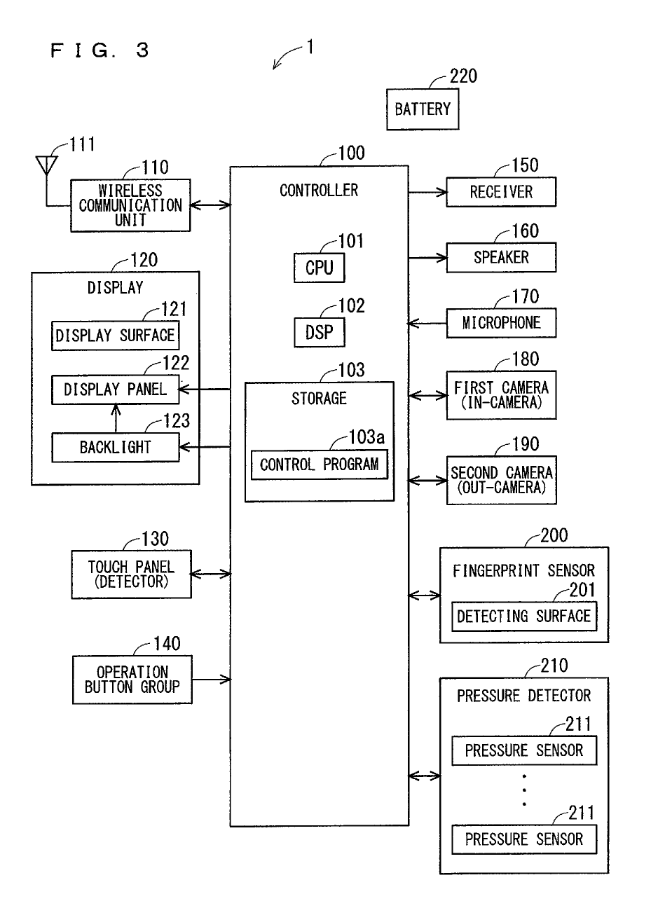

FIG. 3 illustrates a block diagram mainly showing one example of an electrical configuration of the electronic device 1. As illustrated in FIG. 3, the electronic device 1 comprises a controller 100, a wireless communication unit 110, a display 120, a touch panel 130, and an operation button group 140. The electronic device 1 further comprises a receiver 150, a speaker 160, a microphone 170, a first camera 180, a second camera 190, a fingerprint sensor 200, a pressure detector 210, and a battery 220. These components of the electronic device 1 are accommodated inside the device case 11.

The controller 100 can integrally manage operation of the electronic device 1 by controlling other components of the electronic device 1. It can also be said that the controller 100 is a control device or a control circuit. The controller 100 comprises at least one processor for providing control and processing capability to perform various functions as described in further detail below.

In accordance with various embodiments, the at least one processor may be implemented as a single integrated circuit (IC) or as multiple communicatively coupled integrated circuits (IC's) and/or discrete circuits. It is appreciated that the at least one processor can be implemented in accordance with various known technologies.

In one example, the processor comprises one or more circuits or units configurable to perform one or more data computing procedures or processes by executing instructions stored in an associated memory, for example. In other embodiments, the processor may be implemented as firmware (e.g. discrete logic components) configured to perform one or more data computing procedures or processes.

In accordance with various embodiments, the processor may comprise one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one example, the controller 100 comprises a central processing unit (CPU) 101, a digital signal processor (DSP) 102, and a storage 103. The storage 103 comprises a non-transitory recording medium that can be read by the CPU 101 and the DSP 102, such as a read only memory (ROM) and a random access memory (RAM). The ROM of the storage 103 is, for example, a flash ROM (flash memory) that is non-volatile memory. The storage 103 stores a plurality of control programs 103a etc. for controlling the electronic device 1. Various functions of the controller 100 are implemented by the CPU 101 and the DSP 102 executing the various control programs 103a in the storage 103.

Note that the controller 100 may comprise a plurality of CPUs 101. Further, the controller 100 may omit the DSP 102, or may comprise a plurality of DSPs 102. Further, all of the functions of the controller 100 or a part of the functions of the controller 100 may be implemented by a hardware circuit that does not require software to implement the functions of the hardware circuit.

The storage 103 may comprise a non-transitory recording medium that can be read by a computer, other than the ROM and the RAM. The storage 103 may comprise, for example, a small-sized hard disk drive, a solid state drive (SSD), or the like.

The plurality of control programs 103a in the storage 103 comprise various applications (i.e., application programs). The storage 103 stores, for example, a phone application for making a voice call and a video call, a browser for displaying a website, and an email application for creating, viewing, sending, and receiving electronic mail. The storage 103 further stores a camera application for capturing an image of an object using the first camera 180 and the second camera 190, a stored-image display application for displaying a still image and a moving image stored in the storage 103, a music play and control application for controlling to play music data stored in the storage 103, etc. At least one application in the storage 103 may be an application stored in the storage 103 in advance. Further, at least one application in the storage 103 may be an application downloaded from another device by the electronic device 1 and is stored in the storage 103.

The wireless communication unit 110 comprises an antenna 111. The wireless communication unit 110 can, for example, wirelessly communicate in a plurality of types of communication modes using the antenna 111. The wireless communication of the wireless communication unit 110 is controlled by the controller 100.

The wireless communication unit 110 can wirelessly communicate with a base station of a mobile phone system. The wireless communication unit 110 can communicate with a mobile phone device different from the electronic device 1, a web server, or the like via a network of the base station, the Internet, etc. The electronic device 1 can perform data communication, make a voice call, make a video call, etc. with another mobile phone device or the like.

Further, wireless communication can be performed using the wireless communication unit 110 and a wireless local area network (LAN) such as WiFi. Further, the wireless communication unit 110 can perform short-range wireless communication. For example, the wireless communication unit 110 can wirelessly communicate in conformity to Bluetooth (trademark). The wireless communication unit 110 may be able to wirelessly communicate in conformity to at least one of ZigBee (trademark) and near field communication (NFC).

The wireless communication unit 110 subjects an incoming signal received at the antenna 111 to various types of processing such as amplification processing, and then outputs the processed signal to the controller 100. The controller 100 subjects an incoming signal to various types of processing to acquire information contained in the incoming signal. Further, the controller 100 outputs a signal containing information to the wireless communication unit 110. The wireless communication unit 110 subjects an incoming signal to various types of processing such as amplification processing, and then wirelessly transmits the processed signal from the antenna 111.

The display 120 comprises a display surface 121 located on the front surface of the electronic device 1, a display panel 122, and a backlight 123. The display 120 can display various pieces of information on the display surface 121. The display panel 122 is a liquid crystal display panel, for example, and comprises a plurality of pixels (also referred to as a “pixel unit” or a “pixel circuit”). For example, the display panel 122 comprises liquid crystals, a glass substrate, a polarizing plate, etc. The display panel 122 is opposed to the display surface 121 in the device case 11. Information displayed on the display 120 is displayed on the display surface 121 on the surface of the electronic device 1. The backlight 123 irradiates the display panel 122 with light from the back of the display panel 122. For example, the backlight 123 comprises at least one light emitting diode (LED). The display panel 122 can control a transmitting amount of light from the backlight 123 in each pixel by being controlled by the controller 100. With this, the display panel 122 can display various pieces of information. When each pixel of the display panel 122 is controlled by the controller 100 while the backlight 123 is turned on, the display 120 can display various pieces of information such as letters, symbols, and graphics. The controller 100 can control the backlight 123. For example, the controller 100 can turn on and turn off the backlight 123.

Note that the display panel 122 may be a display panel other than a liquid crystal display panel. For example, the display panel 122 may be a light-emitting display panel such as an organic electroluminescent (EL) panel. In this case, the backlight 123 is unnecessary.

The touch panel 130 can detect operation performed on the display surface 121 by a pointer such as a finger. It can also be said that the touch panel 130 is a detector that detects operation input on the display surface 121. The touch panel 130 is, for example, a projected capacitive touch panel. The touch panel 130 is, for example, located on the back of the display surface 121. When the user performs operation on the display surface 121 with a pointer such as a finger, the touch panel 130 can input an electrical signal corresponding to the operation into the controller 100. The controller 100 can specify the details of the operation performed on the display surface 121 based on the electrical signal (output signal) from the touch panel 130. Then, the controller 100 can perform processing according to the specified details of the operation. With this, the controller 100 can perform processing according to the operation input detected by the touch panel 130. Note that, in place of the display panel 122 and the touch panel 130, an in-cell display panel with a built-in touch panel may be adopted. In this case, the display panel also serves as a detector that detects operation input on the display surface 121.

When operated by the user, each operation button of the operation button group 140 can output to the controller 100 an operation signal indicating that the button has been operated. With this, concerning each operation button, the controller 100 can determine whether or not the operation button has been operated. When the controller 100 that has received the operation signal controls other components, a function allocated to the operated operation button is implemented in the electronic device 1.

The microphone 170 can convert sound input from the outside of the electronic device 1 into an electrical sound signal, and can output the converted signal to the controller 100. Sound from the outside of the electronic device 1 is taken into the electronic device 1 through the microphone hole 14, and is then input to the microphone 170.

The speaker 160 is, for example, a dynamic speaker. The speaker 160 can convert an electrical sound signal from the controller 100 into sound, and can output the converted sound. The sound output from the speaker 160 is output to the outside through the speaker hole 13. The user can hear the sound output from the speaker hole 13 even at a place away from the electronic device 1.

The receiver 150 can output received voice sound. The receiver 150 is, for example, a dynamic speaker. The receiver 150 can convert an electrical sound signal from the controller 100 into sound, and can output the converted sound. The sound output from the receiver 150 is output to the outside through the receiver hole 12. The volume of the sound output through the receiver hole 12 is smaller than the volume of the sound output through the speaker hole 13. When the user brings his/her ear closer to the receiver hole 12, the user can hear the sound output through the receiver hole 12. Note that, in place of the receiver 150, a vibration element such as a piezoelectric vibration element that vibrates a front surface portion of the device case 11 may be provided. In this case, sound is conveyed to the user through the vibration of the front surface portion.

The first camera 180 comprises the lens 181, an image sensor, etc. The second camera 190 comprises the lens 191, an image sensor, etc. Each of the first camera 180 and the second camera 190 can capture an image of an object in accordance with the control of the controller 100, can produce a still image or a moving image depicting the captured object, and can output the image to the controller 100.

The lens 181 of the first camera 180 is visibly recognizable from the front surface 11a of the device case 11. Therefore, the first camera 180 can capture an image of an object present at the front surface side (i.e., the display surface 121 side) of the electronic device 1. The first camera 180 is referred to as an in-camera. Meanwhile, the lens 191 of the second camera 190 is visibly recognizable from the back surface 11b of the device case 11. Therefore, the second camera 190 can capture an image of an object present at the back surface side of the electronic device 1. The second camera 190 is referred to as an out-camera.

The fingerprint sensor 200 can detect a fingerprint of a finger touching the detecting surface 201. Further, the fingerprint sensor 200 can output fingerprint information indicating the detected fingerprint to the controller 100.

Here, the state in which a finger touches the detecting surface 201 includes both of a state in which a finger comes in light contact with the detecting surface 201 and a state in which a finger presses the detecting surface 201 (i.e., a state in which a finger depresses the detecting surface 201). Therefore, the fingerprint sensor 200 can detect a fingerprint of a finger when the finger is in light contact with the detecting surface 201. The fingerprint sensor 200 can also detect a fingerprint of a finger when the finger presses the detecting surface 201. The fingerprint sensor 200 can detect a fingerprint of a finger in both of a case where the finger presses gently on the detecting surface 201 and a case where the finger presses hard on the detecting surface 201. A fingerprint detection method of the fingerprint sensor 200 is, for example, an electrostatic capacitance method. The fingerprint detection method of the fingerprint sensor 200 may be a method other than the electrostatic capacitance method. For example, the fingerprint detection method of the fingerprint sensor 200 may be an optical method. As will be described later, the controller 100 can perform processing based on a fingerprint detection result of the fingerprint sensor 200. A fingerprint detected by the fingerprint sensor 200 may be hereinafter referred to as a “detected fingerprint.” Further, fingerprint information output from the fingerprint sensor 200 may be hereinafter referred to as “detected fingerprint information.” Further, the term “fingerprint detection result” itself refers to a fingerprint detection result of the fingerprint sensor 200.

The pressure detector 210 can detect pressure applied on the detecting surface 201. The pressure detector 210 can detect pressure applied on the detecting surface 201 when a finger touches the detecting surface 201, for example. The pressure detector 210 comprises a plurality of pressure sensors 211. Each pressure sensor 211 can detect pressure applied on the detecting surface 201. A pressure detection result of the pressure detector 210 varies depending on the position on the detecting surface 201 at which the pressure is applied. Specifically, in the pressure detector 210, the relation of the pressures detected by the plurality of pressure sensors 211 varies depending on the position on the detecting surface 201 at which the pressure is applied. As will be described later, the controller 100 can perform processing based on a pressure detection result of the pressure detector 210. For example, the controller 100 can specify operation on the detecting surface 201 based on the pressure detection result of the pressure detector 210. Pressure detected by the pressure sensors 211 may be hereinafter referred to as “detected pressure.” Further, the term “pressure detection result” itself refers to a pressure detection result of the pressure detector 210.

The battery 220 can output power of the electronic device 1. The battery 220 is, for example, a rechargeable battery. The power output from the battery 220 is supplied to various components of the electronic device 1, such as the controller 100 and the wireless communication unit 110.

Note that the electronic device 1 may comprise a sensor other than the touch panel 130, the fingerprint sensor 200, and the pressure detector 210. For example, the electronic device 1 may comprise at least one of an accelerometer, an air-pressure sensor, a geomagnetic sensor, a temperature sensor, a proximity sensor, an illuminance sensor, a gyro sensor, and a position detecting sensor.

In the following, operation of the electronic device 1 in which the display surface 121 and the detecting surface 201 are operated with a finger will be mainly described.

<Disposition Example of Fingerprint Sensor and Plurality of Pressure Sensors>

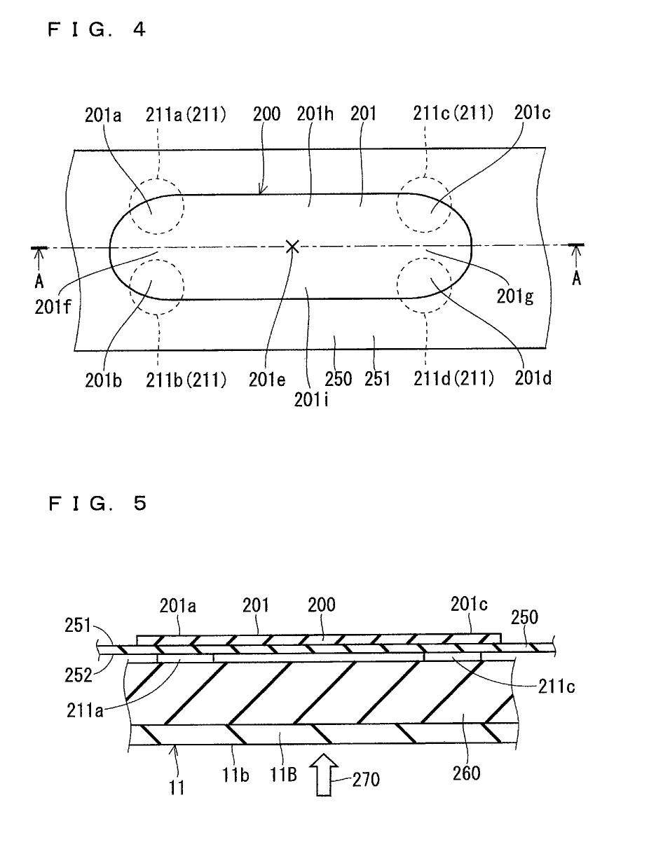

FIG. 4 illustrates a plan view showing one example of a structure around the fingerprint sensor 200 inside the device case 11 of the electronic device 1. FIG. 5 illustrates a diagram showing a cross-sectional structure taken along the line A-A of the structure illustrated in FIG. 4 as seen in the direction of the arrows:

As illustrated in FIG. 4 and FIG. 5, a flexible substrate 250 is located inside the device case 11. The fingerprint sensor 200 and the plurality of pressure sensors 211 forming the pressure detector 210 are mounted on the flexible substrate 250.

The flexible substrate 250 comprises a first main surface 251, and a second main surface 252 on the opposite side of the first main surface 251. The first main surface 251 is located on the front surface 11a side, and the second main surface 252 is located on the back surface 11b side.

The fingerprint sensor 200 is located on the first main surface 251. A signal output from the fingerprint sensor 200 is input into the controller 100 via signal wiring comprised in the flexible substrate 250.

The pressure detector 210 comprises four pressure sensors 211a to 211d, for example. The pressure sensors 211a to 211d are located on the second main surface 252 of the flexible substrate 250. Signals output from the pressure sensors 211a to 211d are input into the controller 100 via signal wiring comprised in the flexible substrate 250.

For example, the pressure sensor 211a is located to partially overlap an upper left portion 201a of the detecting surface 201 of the fingerprint sensor 200 when the pressure sensor 211a is seen through in plan view from the second main surface 252 side of the flexible substrate 250. With reference to FIG. 5, the pressure sensor 211a is located to partially overlap the upper left portion 201a of the detecting surface 201 when the pressure sensor 211a is seen through in plan view from the direction indicated by an arrow 270. In other words, the pressure sensor 211a is located to be partially opposed to the upper left portion 201a of the detecting surface 201 across the flexible substrate 250 in a thickness direction of the electronic device 1 (i.e., a direction perpendicular to the display surface 121). For example, the pressure sensor 211b is located to partially overlap a lower left portion 201b of the detecting surface 201 when the pressure sensor 211b is seen through in plan view from the second main surface 252 side. For example, the pressure sensor 211c is located to partially overlap an upper right portion 201c of the detecting surface 201 when the pressure sensor 211c is seen through in plan view from the second main surface 252 side. For example, the pressure sensor 211d is located to partially overlap a lower right portion 201d of the detecting surface 201 when the pressure sensor 211d is seen through in plan view from the second main surface 252 side. In the pressure detector 210 comprising the plurality of pressure sensors 211a to 211d disposed in this manner, a relation of detected pressures of the pressure sensors 211a to 211d varies depending on the position on the detecting surface 201 at which the pressure is applied.

For example, when the pressure is applied on the upper left portion 201a of the detecting surface 201, detected pressure of the pressure sensor 211a is the highest among detected pressures of the pressure sensors 211a to 211d. When the pressure is applied on the lower left portion 201b of the detecting surface 201, detected pressure of the pressure sensor 211b is the highest among detected pressures of the pressure sensors 211a to 211d. When the pressure is applied on the upper right portion 201c of the detecting surface 201, detected pressure of the pressure sensor 211c is the highest among detected pressures of the pressure sensors 211a to 211d. When the pressure is applied on the lower right portion 201d of the detecting surface 201, detected pressure of the pressure sensor 211d is the highest among detected pressures of the pressure sensors 211a to 211d.

Further, when the pressure is applied on a center 201e of the detecting surface 201, detected pressures of the pressure sensors 211a to 211d are substantially equal. When the pressure is applied on a left center portion 201f of the detecting surface 201, detected pressures of the pressure sensors 211a and 211b are higher than detected pressures of the pressure sensors 211c and 211d, the detected pressures of the pressure sensors 211a and 211b are substantially equal, and the detected pressures of the pressure sensors 211c and 211d are substantially equal. When the pressure is applied on a right center portion 201g of the detecting surface 201, detected pressures of the pressure sensors 211c and 211d are higher than detected pressures of the pressure sensors 211a and 211b, the detected pressures of the pressure sensors 211a and 211b are substantially equal, and the detected pressures of the pressure sensors 211c and 211d are substantially equal. When the pressure is applied on an upper center portion 201h of the detecting surface 201, detected pressures of the pressure sensors 211a and 211c are higher than detected pressures of the pressure sensors 211b and 211d, the detected pressures of the pressure sensors 211a and 211c are substantially equal, and the detected pressures of the pressure sensors 211b and 211d are substantially equal. When the pressure is applied on a lower center portion 201i of the detecting surface 201, detected pressures of the pressure sensors 211b and 211d are higher than detected pressures of the pressure sensors 211a and 211c, the detected pressures of the pressure sensors 211a and 211c are substantially equal, and the detected pressures of the pressure sensors 211b and 211d are substantially equal.

Note that the pressure sensor 211a may completely overlap or may not completely overlap the upper left portion 201a of the detecting surface 201 of the fingerprint sensor 200 when the pressure sensor 211a is seen through in plan view from the second main surface 252 side of the flexible substrate 250. The same also applies to the other pressure sensors 211b to 211d.

As illustrated in FIG. 5, the electronic device 1 comprises a member 260 for eliminating a gap between the pressure sensors 211a to 211d and the device case 11 inside the device case 11. The member 260 is located between the pressure sensors 211a to 211d and a back surface portion 11B of the device case 11 so as to fill the gap between the pressure sensors 211a to 211d and the device case 11. The member 260 may comprise a resin member. The member 260 may comprise a metal member. The member 260 may comprise an electronic component.

With the presence of such a member 260, the pressure applied on the pressure sensors 211a to 211d can be less liable to be released. As a result, the pressure sensors 211a to 211d can properly detect pressure applied on the detecting surface 201. Note that the electronic device 1 may omit the member 260. In this case, at least a part of the back surface portion 11B of the device case 11 may extend up to the pressure sensors 211a to 211d to support the pressure sensors 211a to 211d. Also in this case, the pressure applied on the pressure sensors 211a to 211d can be less liable to be released.

<One Example of Operation Modes of Electronic Device>

The electronic device 1 comprises many operation modes. Examples of the operation modes of the electronic device 1 include a normal mode, a sleep mode, and a shutdown mode. During the shutdown mode, the electronic device 1 is shut down, and most of the functions of the electronic device 1 are stopped. During the sleep mode, some of the functions of the electronic device 1, including a display function, are stopped. The normal mode refers to a state in which the electronic device 1 operates in a mode other than the sleep mode and the shutdown mode. The controller 100 controls predetermined components of the electronic device 1 in accordance with an operation mode to be set, thereby setting the operation mode of the electronic device 1.

During the sleep mode, for example, some components of the electronic device 1, including the display panel 122, the backlight 123, the touch panel 130, the first camera 180, the second camera 190, etc., do not operate. During the shutdown mode, most of the components of the electronic device 1, including the display panel 122, the backlight 123, the touch panel 130, the first camera 180, the second camera 190, etc., do not operate. Power consumption of the electronic device 1 is further reduced in the sleep mode than power consumption in the normal mode. Power consumption of the electronic device 1 is further reduced in the shutdown mode than power consumption in the sleep mode.

Further, the display surface 121 is a non-display state during the sleep mode and the shutdown mode. Here, a display state refers to a state in which the electronic device 1 intentionally performs display on the display surface 121. Further, the non-display state refers to a state in which the electronic device 1 does not intentionally perform display on the display surface 121. In one example, the electronic device 1 cannot intentionally perform display on the display surface 121 when the backlight 123 is turned off. Therefore, the display surface 121 enters the non-display state when the backlight 123 is turned off. In other words, the display surface 121 enters the non-display state when the backlight 123 is not driven. Further, if the display panel 122 is a light-emitting display panel such as an organic EL panel, the display surface 121 enters the non-display state when all of the pixels do not emit light. Specifically, the display surface 121 enters the non-display state when the entire area of the display area in the display panel 122 is turned off.

In one example, when the power button 141 is pressed for a long period of time during the normal mode, the display surface 121 displays a confirmation screen for confirming with the user whether or not the mode should be transitioned from the normal mode to the shutdown mode. When the user performs predetermined operation on the display surface 121 while the display surface 121 displays the confirmation screen, the mode is transitioned from the normal mode to the shutdown mode.

Further, when no operation is performed on the electronic device 1 for a certain period of time or more during the normal mode, the mode is transitioned from the normal mode to the sleep mode. Further, when the power button 141 is pressed for a short period of time during the normal mode, the mode is transitioned from the normal mode to the sleep mode.

On the other hand, when the power button 141 is pressed for a short period of time during the sleep mode, the mode is transitioned from the sleep mode to the normal mode. Specifically, when the power button 141 is pressed for a short period of time during the sleep mode, functions that were stopped when the mode was transitioned to the sleep mode are restored in the electronic device 1. In one example, the normal mode comprises a lock mode (described later). When the power button 141 is pressed for a short period of time during the sleep mode, the mode is transitioned from the sleep mode to the lock mode. Further, as will be described later, when user authentication succeeds during the sleep mode, the mode is transitioned from the sleep mode to the normal mode.

Note that, even if particular description is not given, the normal mode comprises operation modes of the electronic device 1 described below other than the shutdown mode and the sleep mode. Further, the term “operation mode” itself refers to an operation mode of the electronic device 1.

<One Example of Screens Displayed on Display Surface>

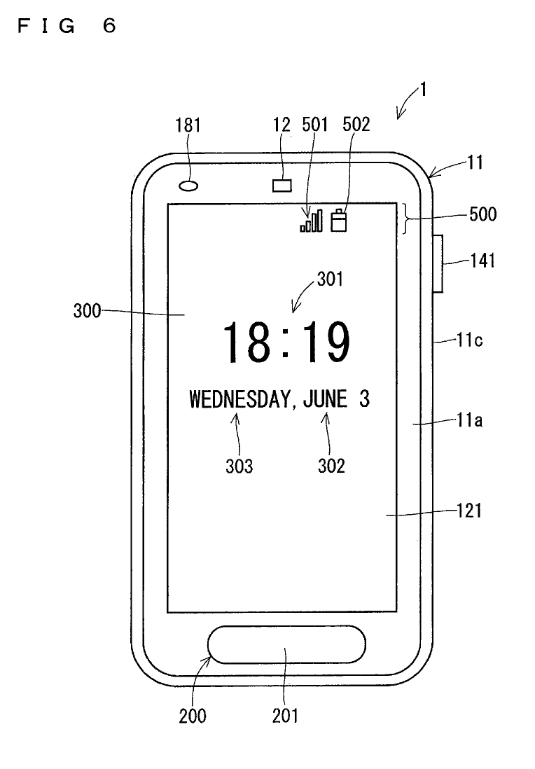

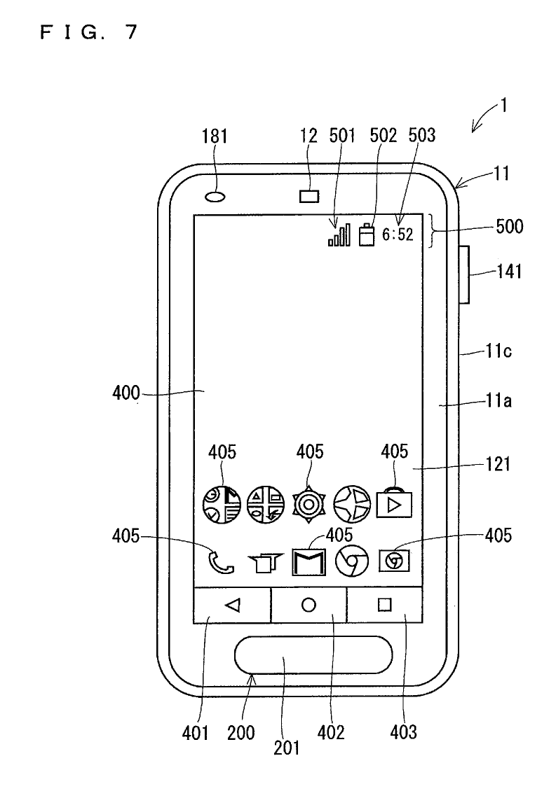

The display surface 121 displays various screens during the normal mode. It can also be said that the screen displayed on the display surface 121 is an image displayed on the display surface 121. The display surface 121 displays a home screen and a lock screen, for example. FIG. 6 illustrates a diagram showing one example of a lock screen 300. FIG. 7 illustrates a diagram showing one example of a home screen 400.

As illustrated in FIG. 6, for example, the lock screen 300 shows current time 301, a current date 302, and a current day of the week 303.

Here, the normal mode comprises the lock mode, which does not allow the user to make the electronic device 1 execute applications other than certain applications (e.g., a phone application and a camera application) among the plurality of applications in the storage 103. The lock mode is also referred to as a screen lock mode. During the lock mode, the user cannot instruct the electronic device 1 to execute the applications other than the certain applications among the plurality of applications in the storage 103. The lock screen 300 is a screen to give notice that the electronic device 1 is in a lock mode, and is displayed on the display surface 121 when the operation mode is the lock mode. Note that, during the lock mode, the user may be unable to make the electronic device 1 execute all of the applications in the storage 103.

When the power button 141 is pressed for a short period of time during the sleep mode, the sleep mode is disabled, and the operation mode enters the lock mode. With this, the display surface 121 displays the lock screen 300. When the user performs predetermined operation on the electronic device 1 while the display surface 121 displays the lock screen 300, the lock mode is disabled in the electronic device 1, and the display on the display surface 121 is transitioned from the lock screen 300 to another screen such as a home screen 400 (see FIG. 7). The state in which the lock mode is disabled during the normal mode may be hereinafter referred to as an “unlocked mode.”

Further, not only limited to the lock screen 300, each screen displayed on the display surface 121 comprises a notification area 500 that gives notice of a state of the electronic device 1. The notification area 500 is also referred to as a status bar. As illustrated in FIG. 6, for example, the notification area 500 comprised in the lock screen 300 comprises an icon (i.e., a graphic FIG. 501 for representing a communication state, and an icon 502 representing a remaining level of the battery. In contrast, as illustrated in FIG. 7, for example, the notification area 500 comprised in the home screen 400 comprises the icons 501 and 502, and an icon 503 representing current time.

Further, when a certain event occurs in the electronic device 1, the notification area 500 shows information about the event that has occurred. The information comprises, for example, an icon that gives notice of reception of a new email message, an icon that gives notice of a missed call, or the like.

As illustrated in FIG. 7, the home screen 400 shows a plurality of operation buttons 401 to 403. Each of the operation buttons 401 to 403 is a software button. The operation buttons 401 to 403 are also shown in a screen other than the home screen 400 during the unlocked mode.

The operation button 401 is, for example, a back button. The back button is an operation button for switching display of the display surface 121 into a previous display. When the user performs predetermined operation on the operation button 401, display of the display surface 121 is switched into a previous display. For example, when the user performs tap operation on the operation button 401, display of the display surface 121 is switched into a previous display. The tap operation is operation in which a pointer such as a finger presses a surface to be operated, and then immediately moves away from the pressing position.

The operation button 402 is, for example, a home button. The home button is an operation button for displaying the home screen 400 on the display surface 121. When the user performs tap operation on the operation button 402, for example, the home screen is displayed on the display surface 121.

The operation button 403 is, for example, a history button. The history button is an operation button for displaying on the display surface 121 the history of applications executed in the electronic device 1. When the user performs tap operation on the operation button 403, for example, the history of applications executed in the electronic device 1 is displayed on the display surface 121.

Further, the home screen 400 shows icons 405 for instructing the electronic device 1 to execute corresponding applications in accordance with applications in the storage 103. In one example of FIG. 7, the home screen 400 shows ten icons 405. The user can select the icon 405 by performing predetermined operation (such as tap operation) on the icon 405. The controller 100 reads out an application corresponding to the selected icon 405 from the storage 103 to execute the application. Specifically, when the touch panel 130 detects predetermined operation performed on the icon 405, the controller 100 reads out an application corresponding to the icon 405 from the storage 103 to execute the application. With this, the user can select the icon 405 by performing operation on the icon 405, and can thus make the electronic device 1 execute an application corresponding to the selected icon 405. For example, when the user performs tap operation on the icon 405 that corresponds to a browser, the browser is executed in the electronic device 1. Further, when the user performs tap operation on the icon 405 that corresponds to a camera application, the camera application is executed in the electronic device 1.

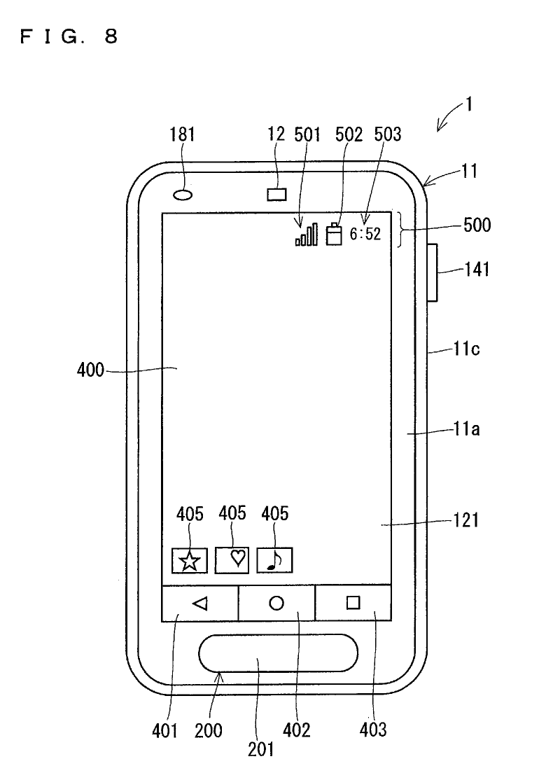

For example, the home screen 400 is made up of a plurality of pages. In FIG. 7, one page of the home screen 400 is illustrated. Each page shows the operation buttons 401 to 403 and the icons 405. The plurality of pages making up the home screen 400 are arrayed virtually in the right and left direction. When the user performs flick operation or swipe operation on the display surface 121 in the right and left direction, an adjacent page is displayed on the display surface 121. The flick operation refers to operation in which a pointer such as a finger flicks the surface to be operated. The swipe operation refers to operation in which a pointer such as a finger moves and then stops with the pointer touching the surface to be operated. The swipe operation is also referred to as slide operation. FIG. 8 illustrates a diagram showing a page different from the page illustrated in FIG. 7. It can be said that each page of the home screen 400 is one type of screen displayed on the display surface 121.

<One Example of Fingerprint Authentication>

When the operation mode is a normal mode, the controller 100 can perform fingerprint authentication based on detected fingerprint information. It can be said that the fingerprint authentication is user authentication based on a fingerprint detection result. When performing fingerprint authentication, the controller 100 compares detected fingerprint information, i.e., fingerprint information indicating a fingerprint detected by the fingerprint sensor 200, and reference fingerprint information stored in the storage 103. The reference fingerprint information is fingerprint information indicating a fingerprint of an authorized user (such as the owner of the electronic device 1). When the detected fingerprint information and the reference fingerprint information are similar to each other as a result of the comparison between both the pieces of fingerprint information, the controller 100 determines that the fingerprint authentication has succeeded. Specifically, when the detected fingerprint information and the reference fingerprint information are similar to each other, the controller 100 determines that the user who has the fingerprint detected by the fingerprint sensor 200 is the authorized user. On the other hand, when the detected fingerprint information and the reference fingerprint information are not similar to each other, the controller 100 determines that the fingerprint authentication has failed. Specifically, the controller 100 determines that the user who has the fingerprint detected by the fingerprint sensor 200 is an unauthorized user.

The normal mode comprises a fingerprint registration mode for registering fingerprint information indicating a fingerprint detected by the fingerprint sensor 200 in the electronic device 1 as reference fingerprint information. The electronic device 1 operates in the fingerprint registration mode when predetermined operation is performed on the display surface 121 during an unlocked mode. When the authorized user touches the detecting surface 201 with a finger (the pad of the finger, to be specific) of his/her hand during the fingerprint registration mode, the fingerprint sensor 200 detects a fingerprint of the finger, and outputs fingerprint information indicating the detected fingerprint. When the electronic device 1 operates in the fingerprint registration mode, for example, the authorized user touches the detecting surface 201 with the pad of a finger of his/her hand a plurality of times while changing a portion of the pad of the finger that touches the detecting surface 201. With this, the fingerprint sensor 200 detects the fingerprint of the finger of the authorized user a plurality of times. Specifically, the fingerprint sensor 200 outputs the detected fingerprint information indicating the fingerprint of the authorized user a plurality of times. The controller 100 collectively stores pieces of the detected fingerprint information that are output a plurality of times from the fingerprint sensor 200 as reference fingerprint information in the storage 103. With this, the reference fingerprint information indicating the fingerprint of the authorized user is registered in the electronic device 1.

Note that the storage 103 may store a plurality of pieces of reference fingerprint information. The plurality of pieces of reference fingerprint information in the storage 103 may comprise, for example, a plurality of pieces of reference fingerprint information that indicate respective fingerprints of a plurality of fingers of one authorized user. Further, the plurality of pieces of reference fingerprint information in the storage 103 may comprise, for example, a plurality of pieces of reference fingerprint information that indicate respective fingerprints of fingers of a plurality of different authorized users (e.g., a plurality of users belonging to one family). When the storage 103 stores a plurality of pieces of reference fingerprint information, the controller 100 compares detected fingerprint information with each of the plurality of pieces of reference fingerprint information in the storage 103. When the plurality of pieces of reference fingerprint information contain a piece of reference fingerprint information that is similar to the detected fingerprint information as a result of the comparison, the controller 100 determines that the fingerprint authentication has succeeded. On the other hand, when the plurality of pieces of reference fingerprint information do not contain a piece of reference fingerprint information that is similar to the detected fingerprint information, the controller 100 determines that the fingerprint authentication has failed.

<One Example of Method of Using Fingerprint Authentication>

The user can use the fingerprint authentication performed by the controller 100 in various situations. For example, the user can use the fingerprint authentication when the user desires to download an application to the electronic device 1 from a server device providing applications. For example, when the controller 100 succeeds in fingerprint authentication, the electronic device 1 that communicates with the server device providing applications downloads an application from the server device. On the other hand, when the controller 100 fails in fingerprint authentication, the electronic device 1 cannot download an application from the server device.

Further, the user can use the fingerprint authentication to make a credit card payment using the electronic device 1. For example, when the controller 100 succeeds in fingerprint authentication, the electronic device 1 that accesses a website managed by a company providing goods notifies a server device or the like managed by the company that the user is willing to make a credit card payment. On the other hand, when the controller 100 fails in fingerprint authentication, the electronic device 1 does not notify the server device or the like that the user is willing to make a credit card payment.

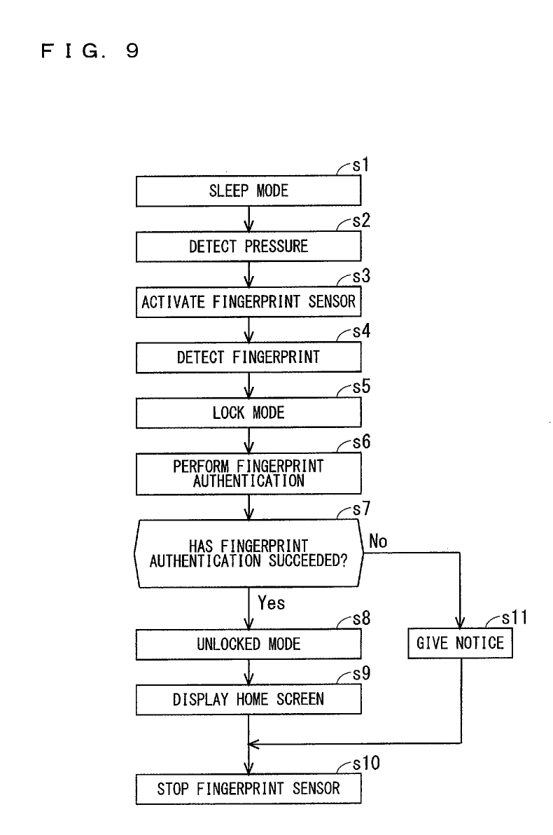

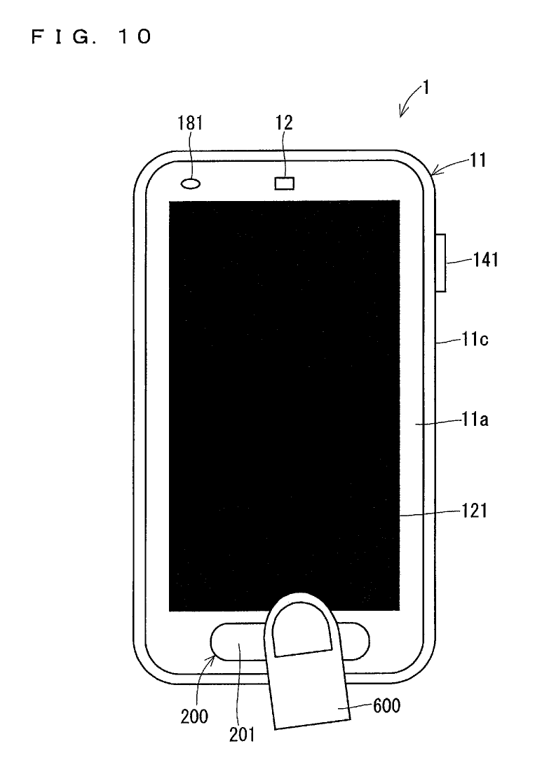

The user can also use the fingerprint authentication to make the electronic device 1 change its operation mode from a sleep mode to an unlocked mode. FIG. 9 illustrates a flowchart showing one example of operation of the electronic device when the operation mode is changed from a sleep mode to an unlocked mode.

In one example, when the operation mode is a sleep mode and a normal mode, each pressure sensor 211 of the pressure detector 210 constantly operates. On the other hand, when the operation mode is a sleep mode and a normal mode, the fingerprint sensor 200 basically stops, and is activated as necessary. Note that, when the operation mode is a shutdown mode, each pressure sensor 211 and the fingerprint sensor 200 constantly stop, for example.

As illustrated in FIG. 9, when the operation mode is set to be a sleep mode (Step s1), and then the controller 100 determines that the pressure detector 210 has detected pressure based on a pressure detection result in Step s2, the controller 100 activates the fingerprint sensor 200 in Step s3. When the controller 100 determines that at least one of the plurality of pressure sensors 211 has detected pressure based on the pressure detection result in Step s2, the controller 100 activates the fingerprint sensor 200 in Step s3.

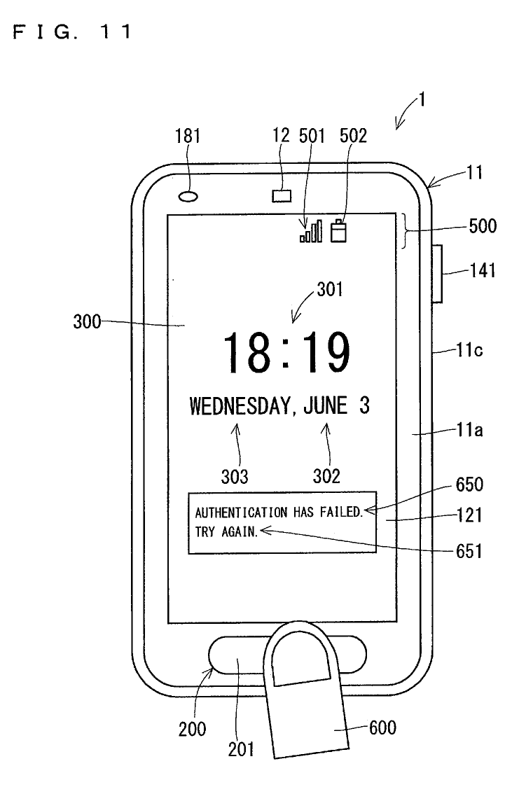

FIG. 10 illustrates a diagram showing one example of how a finger 600 of the user touches the detecting surface 201 when the operation mode is a sleep mode. As in FIG. 10, when the finger 600 touches the detecting surface 201, the pressure detector 210 detects the pressure. Then, the fingerprint sensor 200 is activated.

After Step s3, if the fingerprint sensor 200 detects a fingerprint in Step s4, the controller 100 disables the sleep mode and then set the operation mode to be a lock mode in Step s5. With this, the display surface 121 displays the lock screen 300 (see FIG. 6). Note that, in one example of FIG. 9, Step s5 is executed after Step s4, but may be executed before Step s4.

Next, in Step s6, the controller 100 performs fingerprint authentication as described above based on the fingerprint detection result obtained in Step s4. After Step s6, in Step s7, the controller 100 determines whether or not the fingerprint authentication has succeeded. If it is determined to be Yes in Step s7, the controller 100 disables the lock mode and the set the operation mode to be an unlocked mode in Step s8. Then, in Step s9, the controller 100 makes the display 120 display the home screen 400 (see FIG. 7 and FIG. 8). After that, in Step s10, the controller 100 stops the fingerprint sensor 200.

On the other hand, if it is determined to be No in Step s7, in Step s11, the controller 100 makes the display 120 display failure notification information that gives notice that the user authentication has failed. FIG. 11 illustrates a diagram showing a display example of failure notification information 650. As illustrated in FIG. 11, the failure notification information 650 is shown on the lock screen 300. In one example, as illustrated in FIG. 11, the controller 100 makes the display 120 display re-execution instruction information 651 that instructs the user to touch the detecting surface 201 again, in addition to displaying the failure notification information 650. After Step s11, the controller 100 executes Step s10 to stop the fingerprint sensor 200.

In this manner, in one example, the fingerprint sensor 200 is activated depending on detection of pressure in the pressure detector 210. With this, power consumption of the electronic device 1 can be reduced as compared to the case where the fingerprint sensor 200 constantly operates.

When the operation mode is a lock mode, the user can make the electronic device 1 change its operation mode from the lock mode to an unlocked mode by touching the detecting surface 201 with a finger. When the failure notification information 650 is displayed on the display surface 121 in Step s11 of the above, the operation mode is a lock mode. Therefore, the user can make the electronic device 1 change its operation mode from the lock mode to an unlocked mode by touching the detecting surface 201 with a finger after Step s11.

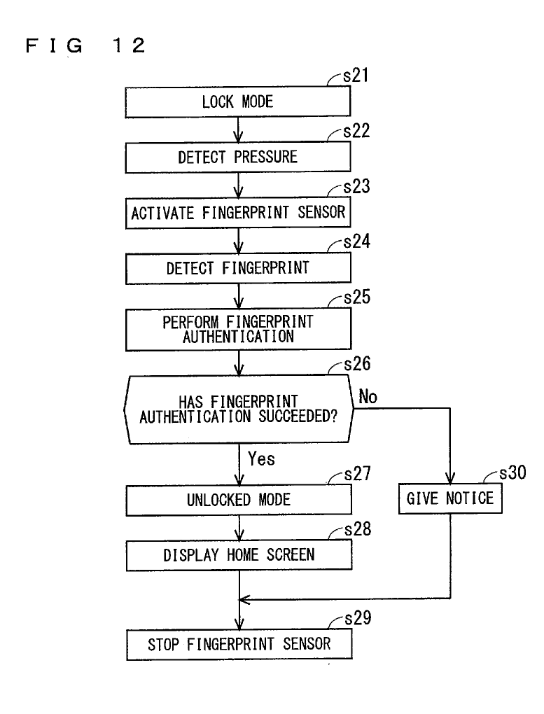

FIG. 12 illustrates a flowchart showing one example of operation of the electronic device 1 when the detecting surface 201 is touched by a finger when the operation mode is a lock mode. As illustrated in FIG. 12, when the operation mode is a lock mode (Step s21), and the controller 100 determines that the pressure detector 210 has detected pressure based on a pressure detection result in Step s22, the controller 100 activates the fingerprint sensor 200 in Step s23, similarly to Step s2 of the above.

After Step s23, when the fingerprint sensor 200 detects a fingerprint in Step s24, in Step s25, the controller 100 performs fingerprint authentication based on the fingerprint detection result obtained in Step s24. After Step s25, in Step s26, the controller 100 determines whether or not the fingerprint authentication has succeeded. If it is determined to be Yes in Step s26, the controller 100 disables the lock mode to set the operation mode to be an unlocked mode in Step s27. Then, in Step s28, the controller 100 makes the display 120 display the home screen 400. After that, in Step s29, the controller 100 stops the fingerprint sensor 200.

On the other hand, if it is determined to be No in Step s26, in Step s30, the controller 100 makes the display 120 display the failure notification information 650, similarly to Step s11 of the above. After that, the controller 100 executes Step s29 to stop the fingerprint sensor 200.

Note that, similarly to the pressure detector 210, if the fingerprint sensor 200 constantly operates in a sleep mode and a normal mode, execution of Steps s2, s3, s22, and s23 of the above is unnecessary.

<Specifying Operation on Detecting Surface by Using Pressure Detection Result>

In one example, when the operation mode is an unlocked mode, the controller 100 can specify operation on the detecting surface 201 based on a pressure detection result.

For example, the controller 100 can specify operation in which a pointer such as a finger moves on the detecting surface 201 based on a pressure detection result. Further, the controller 100 can specify operation in which a pointer such as a finger presses the detecting surface 201 based on a pressure detection result. The operation in which a pointer such as a finger moves on a surface to be operated may be hereinafter simply referred to as “moving operation.” Further, the operation in which a pointer such as a finger presses a surface to be operated may be referred to as “pressing operation.”

The moving operation comprises flick operation and swipe operation, for example. The pressing operation comprises tap operation, long tap operation, and double tap operation, for example. The long tap operation is operation in which a pointer such as a finger presses a surface to be operated, maintains the pressing state for a while, and then moves away from the pressing position. The double tap operation is operation of consecutively repeating twice the operation in which a pointer presses a surface to be operated, and then immediately moves away from the pressing position. Further, the pressing operation not only includes operation in which a pointer presses a surface to be operated and then moves away as in the tap operation, but also includes operation in which a pointer only presses a surface to be operated irrespective of whether or not the pointer moves away from the surface to be operated. This operation may be hereinafter referred to as “simple pressing operation.”

Further, the controller 100 can specify speed and a direction of moving operation on the detecting surface 201 based on a pressure detection result. Further, the controller 100 can specify intensity of pressing operation on the detecting surface 201 based on a pressure detection result.

As described above, the pressure detection result varies depending the position on the detecting surface 201 at which the pressure is applied. Further, when the position on the detecting surface 201 at which pressure is applied continuously changes, the pressure detection result varies depending on the speed of the change of the position. Further, the pressure detection result varies depending on the magnitude of the pressure applied on the detecting surface 201. Therefore, the controller 100 can specify moving operation and pressing operation on the detecting surface 201 based on the pressure detection result, and can also specify speed and a direction of the moving operation and intensity of the pressing operation based on the pressure detection result.

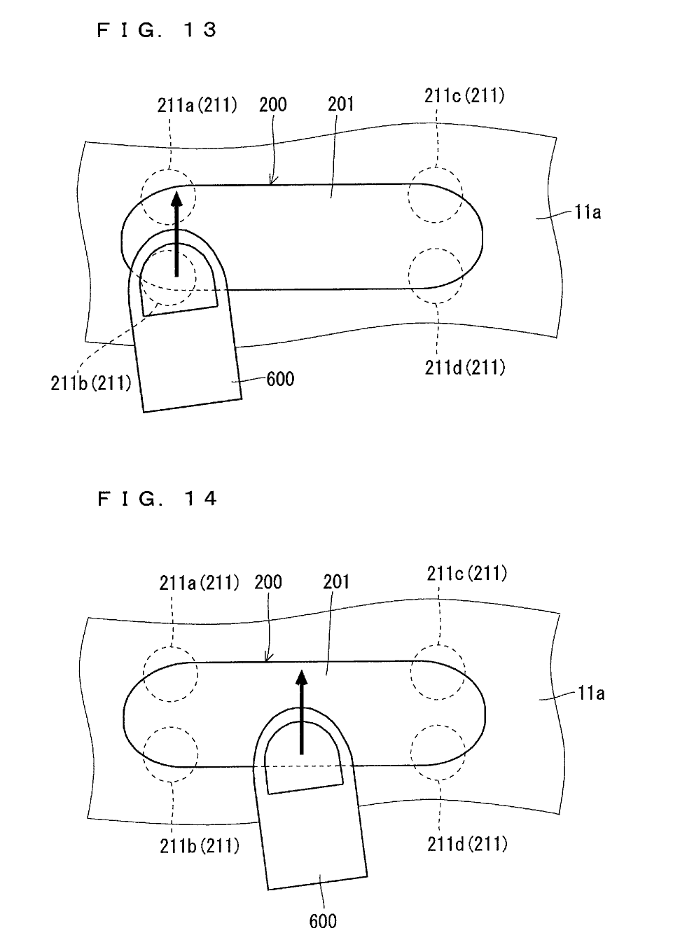

FIG. 13 to FIG. 17 each illustrate a diagram showing one example of moving operation on the detecting surface 201. For example, as illustrated in FIG. 13, a case in which the finger 600 moves upward on a left portion of the detecting surface 201 is considered. In this case, detected pressure of the pressure sensor 211b is gradually reduced in accordance with the movement of the finger 600. Further, the speed in which the detected pressure of the pressure sensor 211b is reduced is increased in accordance with the speed of the movement of the finger 600. Meanwhile, detected pressure of the pressure sensor 211a is increased in accordance with the movement of the finger 600. Further, the speed in which the detected pressure of the pressure sensor 211a is increased is increased in accordance with the speed of the movement of the finger 600. Note that detected pressures of the pressure sensors 211c and 211d are not changed significantly.

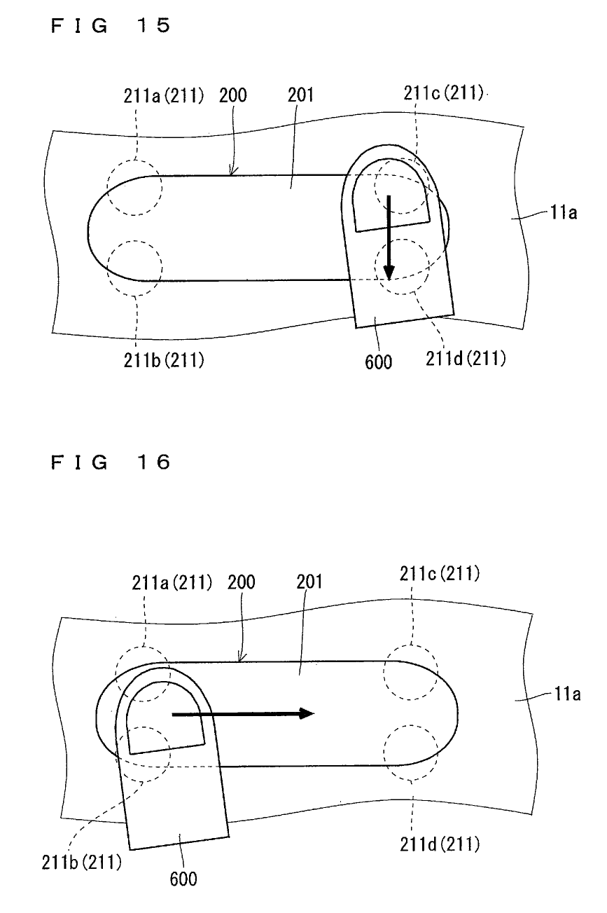

Next, as illustrated in FIG. 14, a case in which the finger 600 moves upward on a center portion between the right and the left of the detecting surface 201 is considered. In this case, detected pressures of the pressure sensors 211b and 211d are gradually reduced and detected pressures of the pressure sensors 211a and 211c are gradually increased in accordance with the movement of the finger 600. Further, the speed in which the detected pressures of the pressure sensors 211b and 211d are reduced and the speed in which the detected pressures of the pressure sensors 211a and 211c are increased are increased in accordance with the speed of the movement of the finger 600.

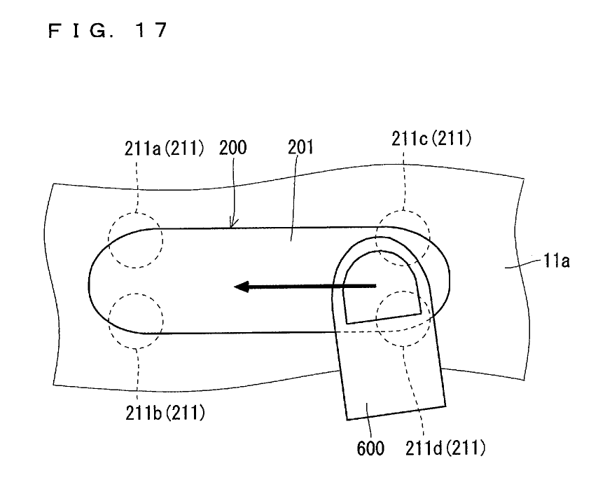

Next, as illustrated in FIG. 15, a case in which the finger 600 moves downward on a right portion of the detecting surface 201 is considered. In this case, detected pressure of the pressure sensor 211c is gradually reduced and detected pressure of the pressure sensor 211d is gradually increased in accordance with the movement of the finger 600. Further, the speed in which the detected pressure of the pressure sensor 211c is reduced and the speed in which the detected pressure of the pressure sensor 211d is increased are increased in accordance with the speed of the movement of the finger 600. Note that detected pressures of the pressure sensors 211a and 211b are not changed significantly.

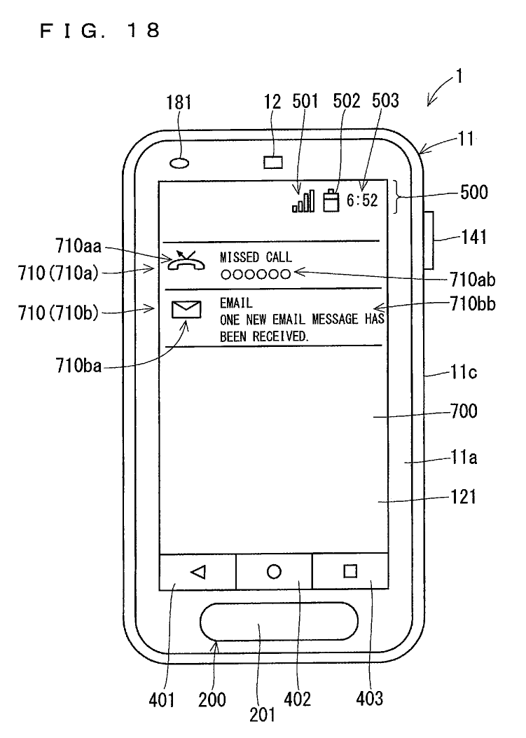

Next, as illustrated in FIG. 16, a case in which the finger 600 moves from the left side to the right side on a center portion between the top and the bottom of the detecting surface 201 is considered. In this case, detected pressures of the pressure sensors 211a and 211b are gradually reduced and detected pressures of the pressure sensors 211c and 211d are gradually increased in accordance with the movement of the finger 600. Further, the speed in which the detected pressures of the pressure sensors 211a and 211b are reduced and the speed in which the detected pressures of the pressure sensors 211c and 211d are increased are increased in accordance with the speed of the movement of the finger 600.

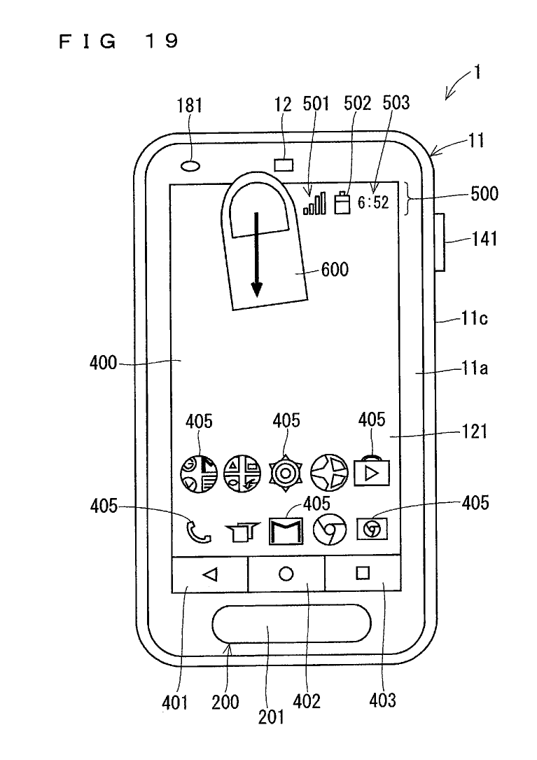

Next, as illustrated in FIG. 17, a case in which the finger 600 moves from the right side to the left side on a center portion between the top and the bottom of the detecting surface 201 is considered. In this case, detected pressures of the pressure sensors 211c and 211d are gradually reduced and detected pressures of the pressure sensors 211a and 211b are gradually increased in accordance with the movement of the finger 600. Further, the speed in which the detected pressures of the pressure sensors 211c and 211d are reduced and the speed in which the detected pressures of the pressure sensors 211a and 211b are increased are increased in accordance with the speed of the movement of the finger 600.

Because the pressure detection result varies depending on moving operation on the detecting surface 201 as described above, the controller 100 can specify the moving operation on the detecting surface 201 based on the pressure detection result. Further, because the pressure detection result varies depending on speed and a direction of moving operation on the detecting surface 201, the controller 100 can specify the speed and the direction of the moving operation on the detecting surface 201 based on the pressure detection result.

Further, because the pressure detection result varies depending on the magnitude of the pressure applied on the detecting surface 201, the controller 100 can specify pressing operation on the detecting surface 201, and can also specify intensity of the pressing operation based on the pressure detection result. It can be said that the controller 100 can specify intensity with which the detecting surface 201 is pressed based on the pressure detection result.

Note that, as can be understood by the above description, the operation on the detecting surface 201 that can be specified by the controller 100 based on the pressure detection result varies depending on the number of the plurality of pressure sensors 211 comprised in the pressure detector 210 as well as the disposition position of the plurality of pressure sensors 211.

<One Example of Processing According to Operation on Detecting Surface>

When the operation mode is an unlocked mode, the controller 100 can perform various types of processing in accordance with specified operation on the detecting surface 201, similarly to the controller 100 that can perform various types of processing in accordance with operation on the display surface 121 detected by the touch panel 130.

For example, the controller 100 can control display of the display 120 (i.e., the display surface 121) in accordance with operation on the detecting surface 201. For example, the controller 100 can scroll the display of the display 120 in accordance with swipe operation and flick operation on the detecting surface 201. For example, when the controller 100 specifies swipe operation on the detecting surface 201, the controller 100 scrolls the display of the display 120 in a direction of the swipe operation (e.g., downward). In this case, the controller 100 may increase the speed of scrolling the display of the display 120 as the speed of the swipe operation is higher. Further, when the controller 100 scrolls the display of the display 120 in accordance with flick operation on the detecting surface 201, the controller 100 may increase a scroll amount of the display of the display 120 as the speed of the flick operation is higher.

Further, the controller 100 may switch a page displayed on the display surface 121 to another page in accordance with swipe operation and flick operation on the detecting surface 201. For example, a case in which the display surface 121 displays the home screen 400 is considered. In this case, when the controller 100 detects rightward flick operation on the detecting surface 201, the controller 100 displays on the display surface 121 a next page (e.g., a page illustrated in FIG. 8) on the right of a currently displayed page (e.g., a page illustrated in FIG. 7).

Further, the controller 100 may make the display 120 display a notification screen 700 that gives notice of information about an event that has occurred in the electronic device 1 in accordance with downward swipe operation and flick operation on the detecting surface 201. In this case, when the controller 100 specifies downward swipe operation or flick operation on the detecting surface 201 based on a pressure detection result, the controller 100 makes the display 120 display the notification screen 700. FIG. 18 illustrates a diagram showing one example of the notification screen 700.

In one example of FIG. 18, a display screen displayed on the display surface 121 comprises the above-mentioned notification area 500 and operation buttons 401 to 403, and the notification screen 700. The notification screen 700 comprises information 710 about an even that has occurred in the electronic device 1. In one example of FIG. 18, the notification screen 700 comprises, as the information 710, information 710a that gives notice of occurrence of a missed call, and information 710b that gives notice of occurrence of reception of a new email message. The information 710a comprises an icon 710aa and text 710ab that give notice of the occurrence of the missed call. The information 710b comprises an icon 710ba and text 710bb that give notice of the occurrence of the reception of the new email message.

When the controller 100 specifies upward swipe operation or flick operation on the detecting surface 201 while the display surface 121 displays the notification screen 700, the controller 100 makes the display 120 clear the notification screen 700 from the display surface 121.

Note that, when the touch panel 130 detects downward swipe operation or flick operation from the notification area 500 on the display surface 121 as illustrated in FIG. 19, the controller 100 may make the display 120 display the notification screen 700 as illustrated in FIG. 18.

Further, when the touch panel 130 detects upward swipe operation or flick operation on the notification screen 700 displayed on the display surface 121, the controller 100 may make the display 120 clear the notification screen 700 from the display surface 121.

Further, the controller 100 may execute an application according to specified operation on the detecting surface 201. In this case, operation on the detecting surface 201 and an application to be executed when the operation is performed are associated with each other. The association relationship between the operation on the detecting surface 201 and the application are stored in the storage 103.

For example, a case in which first to fourth applications in the storage 103 are respectively associated with high-intensity simple pressing operation on the upper left portion 201a, the lower left portion 201b, the upper right portion 201c, and the lower right portion 201d (see FIG. 4) of the detecting surface 201 is considered. In this case, when the controller 100 specifies high-intensity simple pressing operation on the upper left portion 201a of the detecting surface 201, the controller 100 executes the first application (e.g., a camera application) in the storage 103. When detected pressure of the pressure sensor 211a is equal to or more than first reference pressure, the controller 100 determines that high-intensity simple pressing operation has been performed on the upper left portion 201a of the detecting surface 201. When the controller 100 specifies high-intensity simple pressing operation on the lower left portion 201b of the detecting surface 201, the controller 100 executes the second application (e.g., a phone application) in the storage 103. When the controller 100 specifies high-intensity simple pressing operation on the upper right portion 201c of the detecting surface 201, the controller 100 executes the third application (e.g., a music play and control application) in the storage 103. Further, when the controller 100 specifies high-intensity simple pressing operation on the lower right portion 201d of the detecting surface 201, the controller 100 executes the fourth application (e.g., a browser) in the storage 103.

As another example, a case in which the first and second applications in the storage 103 are associated respectively with rightward and leftward flick operation on the detecting surface 201 is considered. In this case, when the controller 100 specifies rightward flick operation on the detecting surface 201, the controller 100 executes the first application in the storage 103 irrespective of the speed of the flick operation. Further, when the controller 100 specifies leftward flick operation on the detecting surface 201, the controller 100 executes the second application in the storage 103 irrespective of the speed of the flick operation.

As another example, a case in which the first and second applications in the storage 103 are associated respectively with high-speed flick operation and low-speed flick operation on the detecting surface 201 is considered. In this case, when the controller 100 specifies high-speed flick operation on the detecting surface 201, the controller 100 executes the first application in the storage 103 irrespective of the direction of the flick operation. Further, when the controller 100 specifies low-speed flick operation on the detecting surface 201, the controller 100 executes the second application in the storage 103 irrespective of the direction of the flick operation.

Note that the association relationship between the operation on the detecting surface 201 and the application stored in the storage 103 may be set by the user.

Further, in one example, the controller 100 specifies all of the speed, direction, and intensity of operation on the detecting surface 201. However, at least one of the speed, direction, and intensity of operation on the detecting surface 201 may be specified.

As described above, the electronic device 1 according to one example comprises the pressure detector 210 comprising the plurality of pressure sensors 211 that can detect pressure applied on the detecting surface 201 of the fingerprint sensor 200. Further, the pressure detection result of the pressure detector 210 varies depending on the position on the detecting surface 201 at which the pressure is applied. Because the electronic device 1 can perform processing using such a pressure detection result, convenience of the electronic device 1 is enhanced.

Further, the thickness of each pressure sensor can be reduced to be smaller than the thickness of a hardware button such as a push button. Therefore, as in one example, when the electronic device 1 comprises the pressure sensors 211 that detect pressure applied on the detecting surface 201, the thickness of the electronic device 1 can be reduced to be smaller than in a case in which the electronic device 1 comprises a hardware button such as a push button that is turned on when the detecting surface 201 is pressed.

Further, as described above, when the controller 100 specifies operation on the detecting surface 201 based on the pressure detection result, and performs processing according to the specified operation, the user can make the electronic device 1 execute processing according to the operation by operating the detecting surface 201. Consequently, convenience of the electronic device 1 is enhanced. As in one example, when the detecting surface 201 is located at a lower end portion of the front surface of the electronic device 1, for example, the user who is holding the electronic device 1 in one hand can easily operate the detecting surface 201 with the hand holding the electronic device 1. Consequently, convenience of the electronic device 1 is further enhanced.

Further, when the controller 100 specifies speed of operation on the detecting surface 201 based on the pressure detection result, the user can make the electronic device 1 execute processing according to the speed of the operation on the detecting surface 201. Further, when the controller 100 specifies a direction of operation on the detecting surface 201 based on the pressure detection result, the user can make the electronic device 1 execute processing according to the direction of the operation on the detecting surface 201. Further, when the controller 100 specifies intensity of operation on the detecting surface 201 based on the pressure detection result, the user can make the electronic device 1 execute processing according to the intensity of the operation on the detecting surface. Consequently, convenience of the electronic device 1 is enhanced.

Further, when the controller 100 controls display of the display 120 in accordance with specified operation on the detecting surface 201, the user can make the electronic device 1 execute control of the display of the display 120 according to the operation by performing operation on the detecting surface 201. Consequently, convenience of the electronic device 1 is enhanced.

Further, when the controller 100 executes an application according to specified operation on the detecting surface 201, the user can make the electronic device 1 execute an application according to the operation by performing operation on the detecting surface 201. Consequently, convenience of the electronic device 1 is enhanced.

<Other Examples of Operation of Electronic Device>

Other examples of operation of the electronic device 1 are described below.

### First Another Example

When the user touches the detecting surface 201 with a finger or the like, the user may accidentally touch the display surface 121. As a result, the touch panel 130 detects accidental operation input on the display surface 121, and the controller 100 may execute processing not intended by the user in accordance with the detected operation input. Particularly, as in one example, when the detecting surface 201 is located on the same surface with the display surface 121 (in one example, the front surface 11a of the device case 11), there is high probability that the touch panel 130 detects accidental operation input on the display surface 121 when the user touches the detecting surface 201 with a finger or the like. For example, the touch panel 130 may detect accidental operation on any one of the operation buttons 401 to 403 that are displayed at a position in the display surface 121 close to the detecting surface 201.

In view of this, in one example, the controller 100 invalidates operation input on at least a part of the display surface 121 while the pressure detector 210 detects pressure. For example, the controller 100 invalidates operation input on at least a part of the display surface 121 when at least one of the plurality of pressure sensors 211 detects pressure. This can reduce the probability that the electronic device 1 executes processing not intended by the user.

The controller 100 may invalidate operation input on the entire area of the display surface 121, or may invalidate operation input on a part of the display surface 121. The controller 100 may invalidate operation input on the entire area of the display surface 121 by stopping operation of the touch panel 130, or may invalidate operation input on the entire area of the display surface 121 by ignoring all the outputs of the touch panel 130. Further, the controller 100 may invalidate operation input on a part of the display surface 121 by stopping operation of a part of the touch panel 130. Further, the controller 100 may invalidate operation input on a part of the display surface 121 by ignoring a part of the outputs of the touch panel 130.

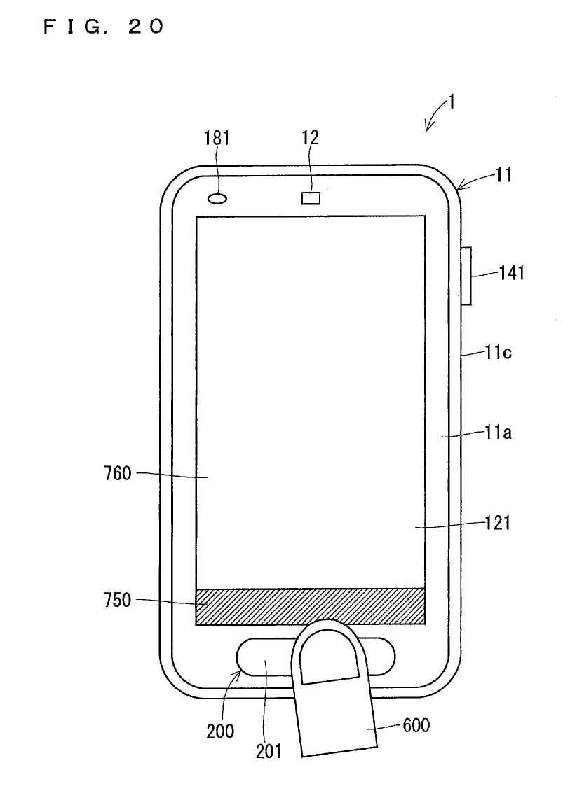

When the controller 100 invalidates operation input on a part of the display surface 121, the display surface 121 comprises a target portion and a non-target portion. Operation input received on the target portion is invalidated. Operation input received on the non-target portion is not invalidated. In this case, the target portion may be located at a position closer to the detecting surface 201 than the non-target portion. FIG. 20 illustrates a diagram showing one example of a target portion 750 and a non-target portion 760. In one example of FIG. 20, a lower end portion of the display surface 121 close to the detecting surface 201 serves as the target portion 750, and the other part serves as the non-target portion 760. For example, a part of the display surface 121 where the operation buttons 401 to 403 are displayed is set as the target portion 750.

Note that the controller 100 may invalidate operation input on at least a part of the display surface 121 while fingerprint authentication is performed and the pressure detector 210 detects pressure. For example, the controller 100 may invalidate operation input on at least a part of the display surface 121 while fingerprint authentication is performed (for example, while Step s6 or Step s25 of the above is executed) and at least one of the plurality of pressure sensors 211 detects pressure. This can reduce the probability that the electronic device 1 executes processing not intended by the user when the user makes the electronic device 1 perform fingerprint authentication by touching the detecting surface 201.

### Second Another Example

When the user makes the electronic device 1 perform fingerprint authentication by touching the detecting surface 201 with a finger, the controller 100 may be unable to properly perform fingerprint authentication when the position of the finger on the detecting surface 201 is not proper. For example, when the position of the finger on the detecting surface 201 is the left edge or the right edge of the detecting surface 201, the controller 100 may be unable to properly perform fingerprint authentication.

In view of this, in one example, when the controller 100 performs fingerprint authentication, the controller 100 specifies deviation of the position of a finger on the detecting surface 201 with respect to a reference position based on a pressure detection result. Then, the controller 100 notifies a notification unit, that gives notice to the user, of the specified deviation. The notification unit that gives notice to the user comprises the display 120 and the speaker 160. Further, when the electronic device 1 comprises a vibrator that can transmit vibration to the user touching the device case 11 by vibrating the device case 11, the notification unit comprises the vibrator. Further, when the electronic device 1 comprises a light emitter (e.g., an LED) that emits light to the outside of the device case 11, the notification unit comprises the light emitter.

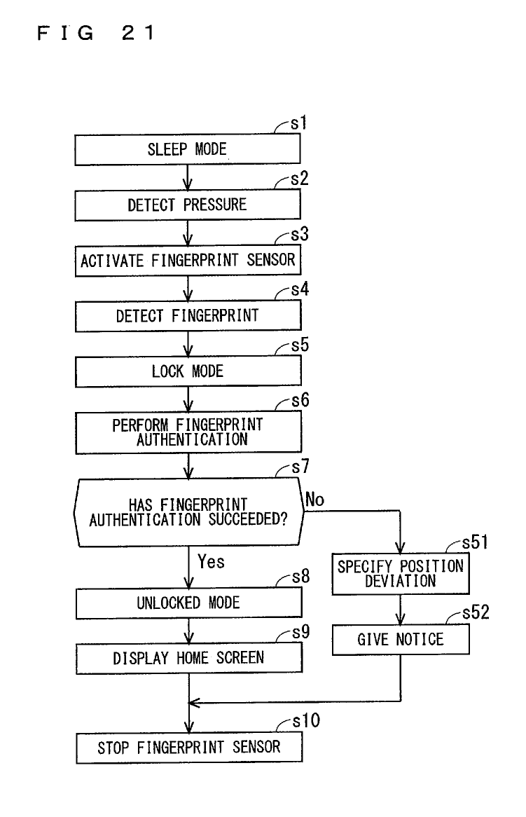

FIG. 21 illustrates a flowchart showing one example of operation of the electronic device 1 according to one example. The flowchart illustrated in FIG. 21 is a flowchart in which Steps s51 and s52 are executed instead of Step s11 in the flowchart illustrated in FIG. 9 described above.

As illustrated in FIG. 21, if it is determined in Step s7 that the fingerprint authentication has failed, in Step s51, the controller 100 specifies deviation of the position of a finger on the detecting surface 201 with respect to a reference position based on the pressure detection result obtained in Step s2. As the reference position, for example, the center 201e (see FIG. 4) of the detecting surface 201 is adopted.

In Step s51, for example, when detected pressure of the pressure sensor 211a is higher than detected pressure of the pressure sensor 211c, the controller 100 determines that the position of the finger on the detecting surface 201 is deviated to the left with respect to the reference position. Further, when detected pressure of the pressure sensor 211b is higher than detected pressure of the pressure sensor 211d, the controller 100 determines that the position of the finger on the detecting surface 201 is deviated to the left with respect to the reference position. In contrast, when detected pressure of the pressure sensor 211c is higher than detected pressure of the pressure sensor 211a, the controller 100 determines that the position of the finger on the detecting surface 201 is deviated to the right with respect to the reference position. Further, when detected pressure of the pressure sensor 211d is higher than detected pressure of the pressure sensor 211b, the controller 100 determines that the position of the finger on the detecting surface 201 is deviated to the right with respect to the reference position. The deviation of the position of the finger on the detecting surface 201 with respect to the reference position may be hereinafter simply referred to as “position deviation.”

After Step s51, in Step s52, the controller 100 notifies the notification unit of the position deviation. For example, the controller 100 makes the display 120 display position deviation notification information 652 that gives notice of the position deviation. After Step s53, Step s10 is executed.

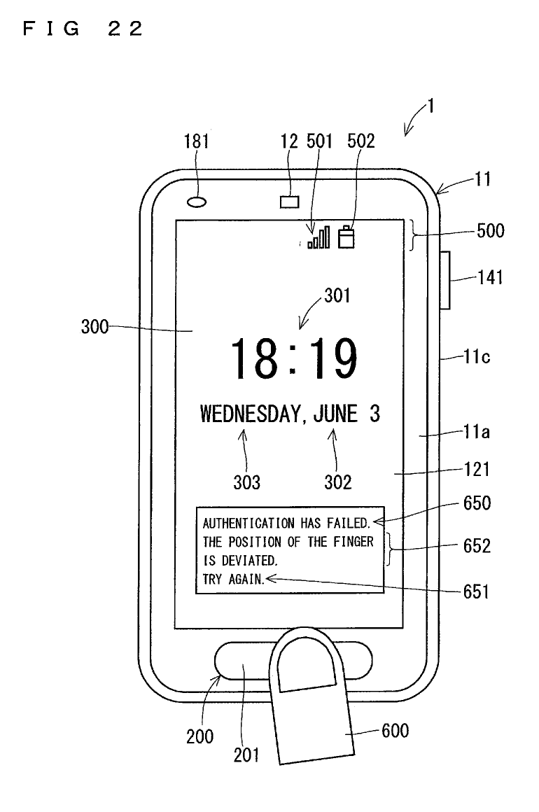

FIG. 22 illustrates a diagram showing one example of the position deviation notification information 652. As illustrated in FIG. 22, in one example, the controller 100 makes the display 120 display the failure notification information 650 and the re-execution instruction information 651, in addition to displaying the position deviation notification information 652. Note that, when the position of the finger on the detecting surface 201 is not deviated with respect to the reference position, the user may not be notified of position deviation, and the failure notification information 650 and the re-execution instruction information 651 may be displayed on the display surface 121 as in FIG. 11 described above, for example. In this case, information indicating that there is no position deviation may be displayed on the display surface 121.

Step s51 may be executed after Step s2 and before Step s7. Further, Steps s51 and s52 may be executed instead of Step s30 in the flowchart illustrated in FIG. 12 described above. In this case, Step s51 may be executed after Step s22 and before Step s26.

The notification unit that gives notice of position deviation is not limited to the display unit 120. For example, the speaker 160 may give notice of position deviation. In this case, for example, the speaker 160 may output a voice saying “the position of the finger is deviated.” Further, when the electronic device 1 comprises a vibrator that vibrates the device case 11, the vibrator may give notice of position deviation. In this case, the vibrator may notify the user of position deviation by vibrating the device case 11 with a certain vibration pattern. Further, when the electronic device 1 comprises a light emitter such as an LED, the light emitter may give notice of position deviation. In this case, the light emitter may notify the user of position deviation by emitting light with a certain light emitting pattern. Further, at least two of the display 120, the speaker 160, the vibrator, and the light emitter may give notice of the position deviation.

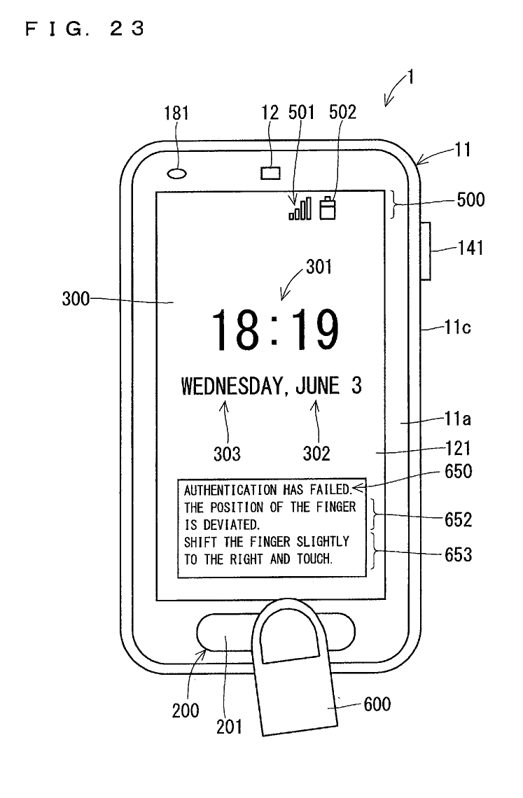

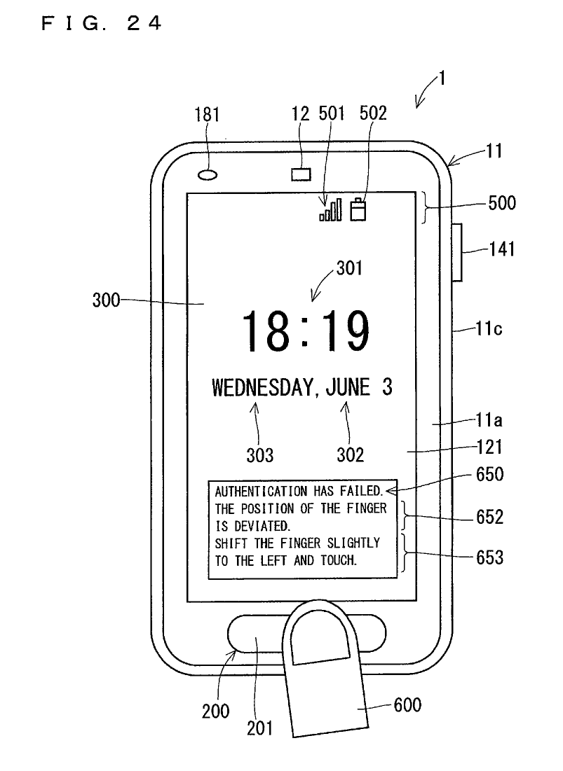

When the notification unit gives notice of position deviation, the notification unit may give notice of guide information 653 that guides change of the position of the finger on the detecting surface 201. FIG. 23 and FIG. 24 each illustrate a diagram showing one example of the guide information 653 notified by the display 120, i.e., the guide information 653 displayed by the display 120. FIG. 23 illustrates the guide information 653 when the position of the finger on the detecting surface 201 is deviated toward the left with respect to the reference position. FIG. 24 illustrates the guide information 653 when the position of the finger on the detecting surface 201 is deviated toward the right with respect to the reference position.

As illustrated in FIG. 23 and FIG. 24, the display surface 121 displays the guide information 653, as well as displaying the failure notification information 650 and the position deviation notification information 652. The guide information 653 illustrated in FIG. 23 includes text saying “shift the finger slightly to the right and touch.” Therefore, it can be said that the guide information 653 illustrated in FIG. 23 is information that guides the user to shift the position of the finger on the detecting surface 201 toward the right. In contrast, the guide information 653 illustrated in FIG. 24 includes text saying “shift the finger slightly to the left and touch.” Therefore, it can be said that the guide information 653 illustrated in FIG. 24 is information that guides the user to shift the position of the finger on the detecting surface 201 toward the left. It can be said that the guide information 653 is notification information that gives notice of position deviation because the user can understand from the guide information 653 that there is position deviation. The controller 100 may not make the display 120 display the position deviation notification information 652 when the controller 100 makes the display 120 display the guide information 653.

Note that at least one of the display 120, the speaker 160, the vibrator, and the light emitter may give notice of the guide information. The speaker 160 may give notice of the guide information by outputting a voice that gives notice of a direction in which the finger should be shifted. The vibrator may give notice of the guide information by changing vibration patterns depending on the direction in which the finger should be shifted. The light emitter may give notice of the guide information by changing light emitting patterns depending on the direction in which the finger should be shifted.

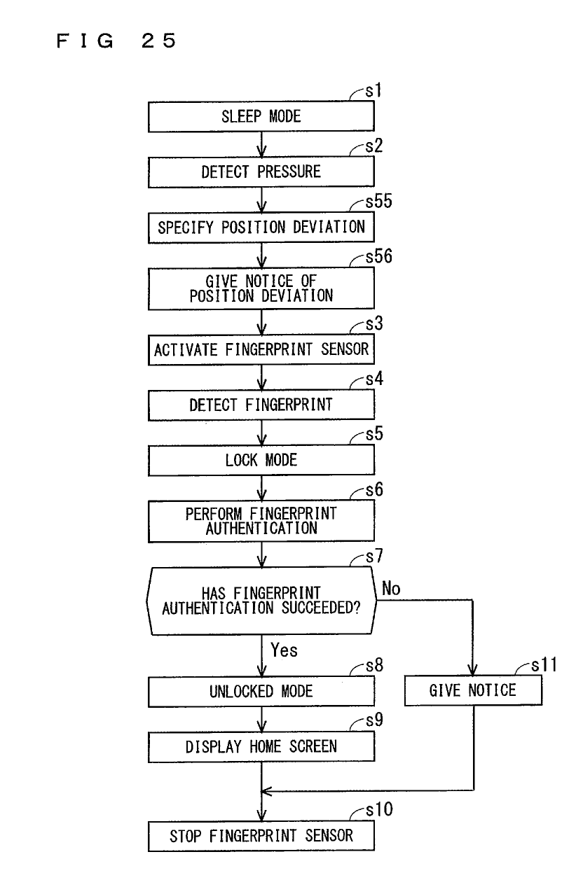

In one example, the user is notified of position deviation after the fingerprint authentication fails. However, the user may be notified of position deviation before the fingerprint sensor 200 detects a fingerprint. FIG. 25 illustrates a flowchart showing one example of operation of the electronic device 1 in this case. The flowchart illustrated in FIG. 25 is a flowchart in which Steps s55 and s56 are executed between Step s2 and Step s3 in the flowchart illustrated in FIG. 9 described above.

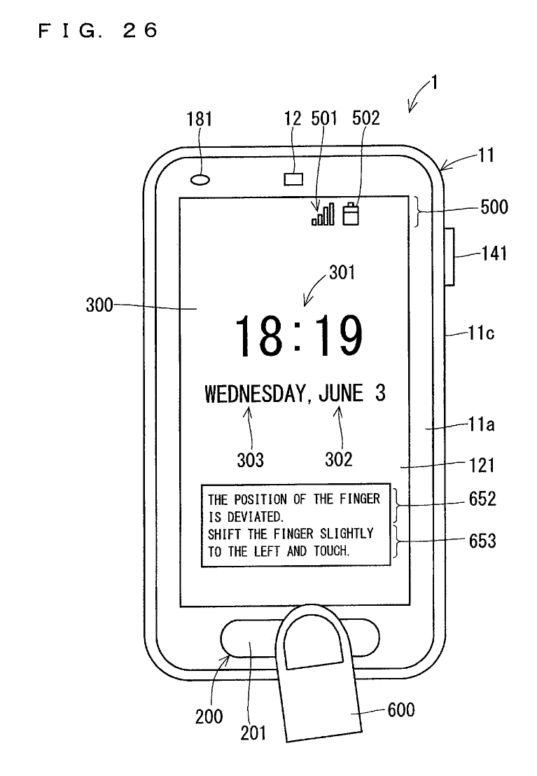

As illustrated in FIG. 25, after the execution of Step s2, in Step s55, the controller 100 specifies position deviation based on the pressure detection result obtained in Step s2, similarly to Step s51 described above. Then, in Step s56, the controller 100 notifies the notification unit of the specified position deviation. For example, when the notification unit is the display 120, the controller 100 makes the display 120 display the position deviation notification information 652 that gives notice of the position deviation. FIG. 26 illustrates a diagram showing one example of the position deviation notification information 652. In one example of FIG. 26, the display surface 121 displays the guide information 653 as well as the position deviation notification information 652, but may not display the guide information 653.

After the elapse of a predetermined period of time since the execution of Step s56, the controller 100 executes Step s3 to activate the fingerprint sensor 200. The electronic device 1 operates similarly thereafter.

Note that, if it is determined in Step s55 that the position of the finger on the detecting surface 201 is not deviated with respect to the reference position, Step s56 is not executed.

Further, Steps s55 and s56 may be executed between Step s22 and Step s23 in the flowchart illustrated in FIG. 12 described above.

Because the user is notified of the position deviation as described above, convenience of the electronic device 1 is enhanced.

Further, when the user is notified of the guide information that suggests changing the position of the finger on the detecting surface 201, convenience of the electronic device 1 is further enhanced.

Note that, even when there is position deviation when fingerprint authentication is performed, it can be said that there is little necessity that the user be informed of the position deviation on the condition that the fingerprint authentication succeeds. Therefore, when the position deviation is notified after the fingerprint authentication fails as illustrated in FIG. 21, convenience of the electronic device 1 is enhanced as compared to one example of FIG. 25.

### Third Another Example

When the user makes the electronic device 1 perform fingerprint authentication by touching the detecting surface 201 with a finger, the controller 100 may be unable to properly perform fingerprint authentication when the pressure applied on the detecting surface 201 is not proper.

In view of this, in one example, when fingerprint authentication is performed, the controller 100 performs pressure determining processing for determining whether or not pressure applied to the detecting surface 201 is proper for the fingerprint authentication. Then, when the controller 100 determines that the pressure applied on the detecting surface 201 is not proper in the pressure determining processing, the controller 100 notifies the notification unit that the pressure is not proper. As the notification unit of one example, similarly to the above second another example, at least one of the display 120, the speaker 160, the vibrator, and the light emitter may be used.

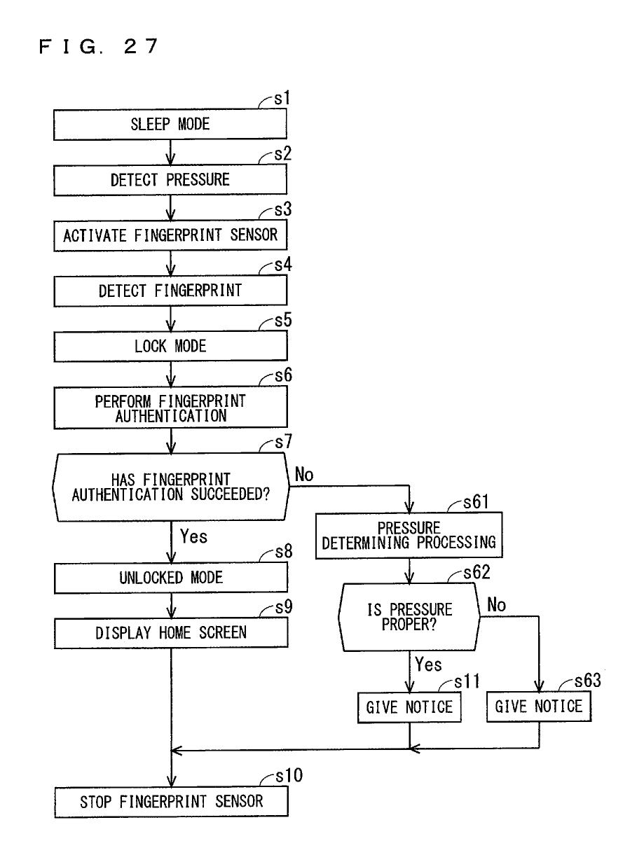

FIG. 27 illustrates a flowchart showing one example of operation of the electronic device 1 according to one example. The flowchart illustrated in FIG. 27 is a flowchart in which Steps s61 to s63 are added to the flowchart illustrated in FIG. 9 described above.

As illustrated in FIG. 27, if it is determined in Step s7 that the fingerprint authentication has failed, in Step s61, the controller 100 performs pressure determining processing for determining whether or not the pressure applied on the detecting surface 201 is proper for the fingerprint authentication based on the pressure detection result obtained in Step s2. In other words, the controller 100 determines whether or not the degree of pressure applied on the detecting surface 201 is such a degree of pressure that the fingerprint authentication can be properly performed based on the pressure detection result.

Here, when the pressure applied on the detecting surface 201 when fingerprint authentication is performed is too high, a detected fingerprint may appear as blocked shadows, and the controller 100 may be unable to properly perform the fingerprint authentication. In one example, when the pressure applied on the detecting surface 201 is high, it is determined that the pressure applied on the detecting surface 201 is not proper for the fingerprint authentication. Specifically, in Step s61, for example, when a mean value of the detected pressures of the plurality of pressure sensors 211 is equal to or more than second reference pressure, the controller 100 determines that the pressure applied on the detecting surface 201 is not proper. On the other hand, when the mean value of the detected pressures of the plurality of pressure sensors 211 is less than the second reference pressure, the controller 100 determines that the pressure applied on the detecting surface 201 is proper.

The second reference pressure is stored in the storage 103 in advance, for example. The second reference pressure is set to be such a value that the probability of failure in fingerprint authentication of the authorized user rises when pressure applied on the detecting surface 201 exceeds the value. The second reference pressure can be set based on an experiment using an actual device, a simulation, or the like. Note that the controller 100 may determine that the pressure applied on the detecting surface 201 is not proper when the mean value of the detected pressures of the plurality of pressure sensors 211 is more than the second reference pressure, and may determine that the pressure applied on the detecting surface 201 is proper when the mean value of the detected pressures of the plurality of pressure sensors 211 is equal to or less than the second reference pressure.

If the controller 100 determines that the pressure applied on the detecting surface 201 is proper in the pressure determining processing of Step s61 (Yes in Step s62), the controller 100 executes Step s11 described above to make the display 120 display the failure notification information 650 and the re-execution instruction information 651, similarly to FIG. 11 described above. After that, Step s10 is executed, and the fingerprint sensor 200 stops.

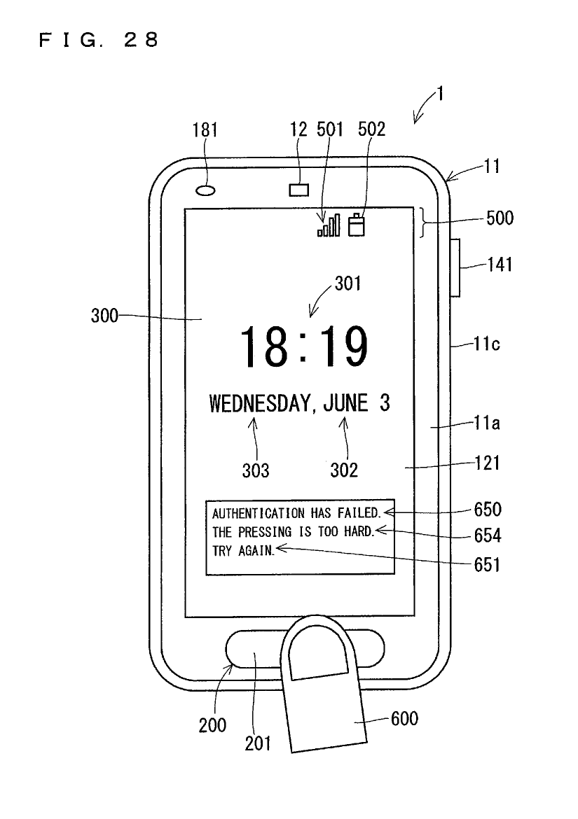

On the other hand, if the controller 100 determines that the pressure applied on the detecting surface 201 is not proper in the pressure determining processing of Step s61 (No in Step s62), in Step s63, the controller 100 notifies the notification unit that the pressure applied on the detecting surface 201 is not proper. FIG. 28 illustrates a diagram showing one example of how the display 120 as the notification unit gives notice that the pressure applied on the detecting surface 201 is not proper. As illustrated in FIG. 28, for example, the display 120 displays on the display surface 121 notification information 654 that gives notice that the pressure applied on the detecting surface 201 is not proper, as well as displaying the failure notification information 650 and the re-execution instruction information 651. After Step s63, Step s10 is executed, and the fingerprint sensor 200 stops.

Step s61 may be executed after Step s2 and before Step s7. Further, Steps s61 to s63 may be executed in the flowchart illustrated in FIG. 12 described above. In this case, if it is determined to be No in Step s26, Steps s61 and s62 are executed. If it is determined to be Yes in Step s62, Step s30 is executed. If it is determined to be No in Step s62, Step s63 is executed. Step s61 may be executed after Step s22 and before Step s26.

Further, Steps s61 to s63 may be executed in the flowchart illustrated in FIG. 21 described above. In this case, if it is determined to be No in Step s7, Steps s61 and s62 are executed immediately before or immediately after Step s51. If it is determined to be Yes in Step s62, Step s52 is executed. On the other hand, if it is determined to be No in Step s62, Step s63 is executed. In Step s63, for example, the display surface 121 displays the position deviation notification information 652 and the guide information 653. Further, similarly to FIG. 27, Steps s61 to s63 may be executed in the flowchart illustrated in FIG. 25 described above.

Note that, in Step s63, for example, the speaker 160 may output a voice saying “the pressing is too hard.” Further, the vibrator may notify the user that the pressure applied on the detecting surface 201 is not proper by vibrating the device case 11 with a certain vibration pattern. Further, the light emitter may notify the user that the pressure applied on the detecting surface 201 is not proper by emitting light with a certain light emitting pattern.

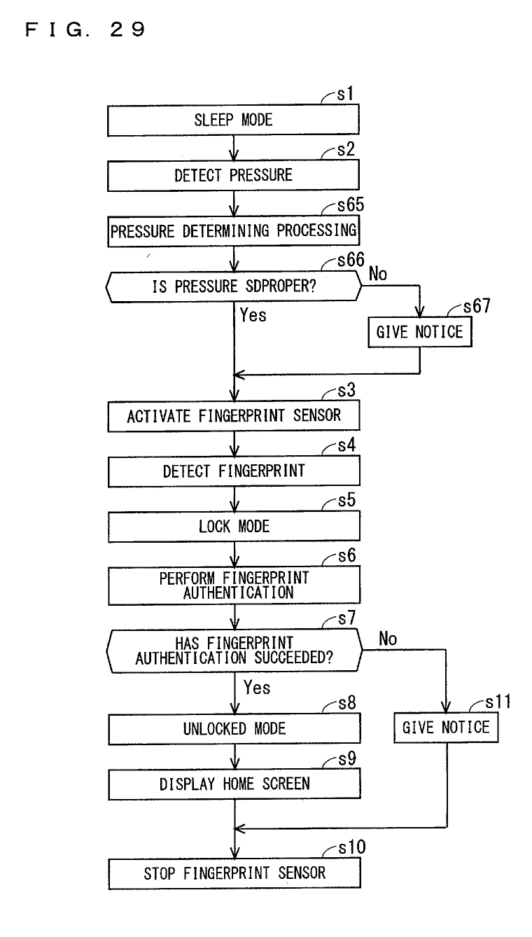

In one example, the user is notified that the pressure applied on the detecting surface 201 is not proper after the fingerprint authentication fails, but the user may be notified before the fingerprint sensor 200 detects a fingerprint. FIG. 29 illustrates a flowchart showing one example of operation of the electronic device 1 in this case. The flowchart illustrated in FIG. 29 is a flowchart in which Steps s65 to s67 are executed between Step s2 and Step s3 in the flowchart illustrated in FIG. 9 described above.

As illustrated in FIG. 29, after the execution of Step s2, in Step s65, the controller 100 performs pressure determining processing based on the pressure detection result obtained in Step s2, similarly to Step s61 described above. If the controller 100 determines that the pressure applied on the detecting surface 201 is proper in the pressure determining processing (Yes in Step s66), the controller 100 executes Step s3 to activate the fingerprint sensor 200. The electronic device 1 operates similarly thereafter.

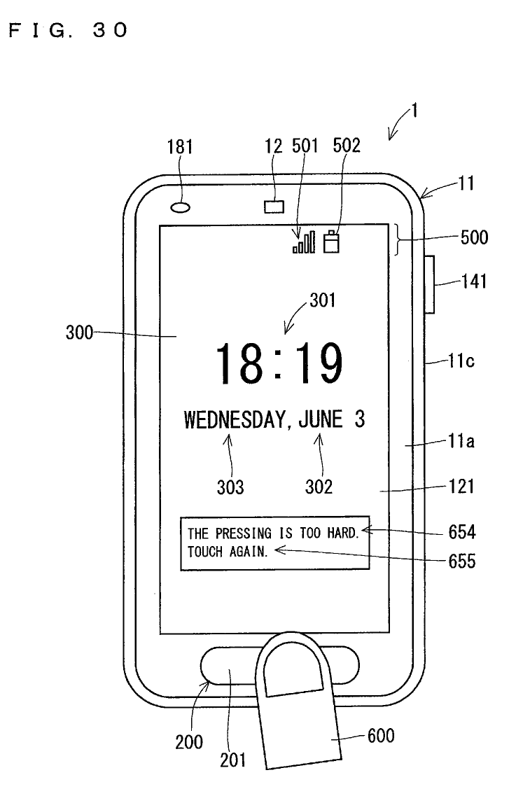

On the other hand, if the controller 100 determines that the pressure applied on the detecting surface 201 is not proper in the pressure determining processing (No in Step s66), in Step s67, the controller 100 notifies the notification unit that the pressure applied on the detecting surface 201 is not proper. For example, if the notification unit is the display 120, the controller 100 makes the display 120 display the notification information 654. FIG. 30 illustrates a diagram showing one example of the notification information 654. As illustrated in FIG. 30, the display 120 may display on the display surface 121 notification information 655 that notifies the user that the user should touch the detecting surface 201 again, as well as displaying the notification information 654.

After the elapse of a predetermined period of time since the execution of Step s67, the controller 100 executes Step s3 to activate the fingerprint sensor 200. The electronic device 1 operates similarly thereafter.

Note that Steps s65 to s67 may be executed between Step s22 and Step s23 in the flowchart illustrated in FIG. 12 described above.

Further, similarly to FIG. 29, Steps s65 to s67 may be executed between Step s2 and Step s3 in the flowchart illustrated in FIG. 21 described above. Further, Steps s65 to s67 may be executed in the flowchart illustrated in FIG. 25 described above. In this case, Steps s65 and s66 are executed immediately before or immediately after Step s55. If it is determined to be Yes in Step s66, Step s56 is executed. On the other hand, if it is determined to be No in Step s66, Step s67 is executed. In Step s67, for example, the display surface 121 displays the position deviation notification information 652 and the guide information 653.

In one example, because the user is notified that the pressure applied on the detecting surface 201 is not proper for the fingerprint authentication as described above, convenience of the electronic device 1 is enhanced.

Further, even when the controller 100 determines that the pressure applied on the detecting surface 201 is not proper when fingerprint authentication is performed, it can be said that there is little necessity that the user be informed that the pressure applied on the detecting surface 201 is not proper on the condition that the fingerprint authentication succeeds. Therefore, when the user is notified that the pressure applied on the detecting surface 201 is not proper after the fingerprint authentication fails as illustrated in FIG. 27, convenience of the electronic device 1 is enhanced as compared to one example of FIG. 29.

Note that the controller 100 may set the second reference pressure to be used in the pressure determining processing based on the pressure detection result. In this case, when the operation mode is a fingerprint registration mode, the controller 100 may set the second reference pressure based on the pressure detection result obtained when the reference fingerprint information is registered in the electronic device 1. As described above, when the reference fingerprint information is registered in the electronic device 1, the detecting surface 201 is touched by the user a plurality of times. When the operation mode is a fingerprint registration mode, the controller 100 calculates a mean value of the detected pressures of the plurality of pressure sensors 211 as a primary mean value every time the detecting surface 201 is touched. With this, when the user touches the detecting surface 201 a plurality of times when the operation mode is a fingerprint registration mode, a plurality of primary mean values can be obtained. The controller 100 calculates a mean value of the obtained plurality of primary mean values as a secondary mean value. The controller 100 sets the second reference pressure based on the calculated secondary mean value. For example, the controller 100 uses a value that is 1.5 to 2 times larger than the secondary mean value as the second reference pressure. Note that a method of setting the second reference pressure is not limited to the above. Further, the second reference pressure may be determined based on a pressure detection result that is obtained when the operation mode is other than the fingerprint registration mode.

In this manner, when the controller 100 sets the second reference pressure based on a pressure detection result that is obtained when the reference fingerprint information is registered, the user need not separately perform operation for registering the reference fingerprint information in the electronic device 1, and operation for setting the second reference pressure in the electronic device 1. Consequently, operation performed by the user on the electronic device 1 is simplified. As a result, convenience of the electronic device 1 is enhanced.

### Fourth Another Example

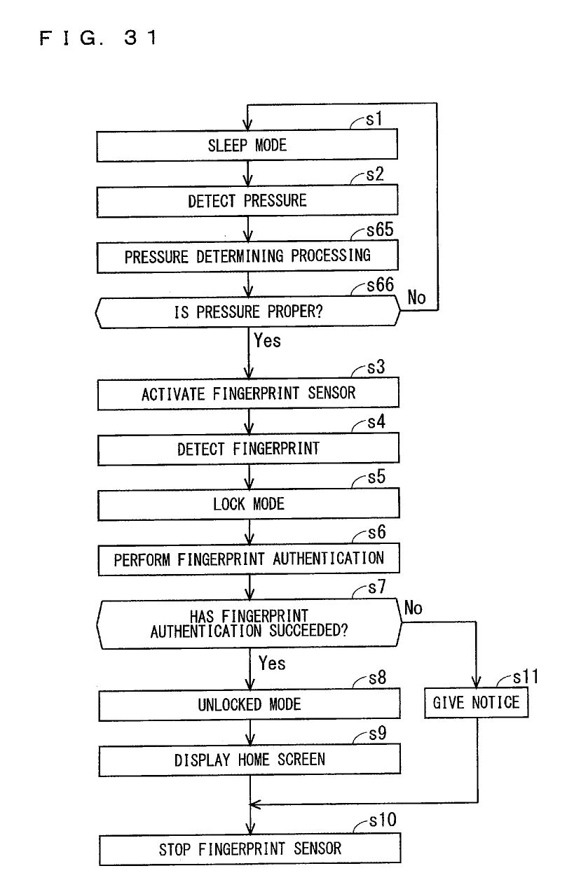

In one example, the controller 100 performs fingerprint authentication when the pressure detection result satisfies a first condition, and does not perform fingerprint authentication when the pressure detection result satisfies a second condition. FIG. 31 illustrates a flowchart showing one example of operation of the electronic device 1 according to one example. The flowchart illustrated in FIG. 31 is a flowchart in which, if it is determined to be No in Step s66, Step s1 is executed without execution of Step s67 in the flowchart illustrated in FIG. 29.

As illustrated in FIG. 31, if it is determined that pressure is proper in the pressure determining processing of Step s65 (Yes in Step s66), Step s3 is executed to activate the fingerprint sensor 200. The electronic device 1 operates similarly thereafter. On the other hand, if it is determined that pressure is not proper in the pressure determining processing of Step s65 (No in Step s66), the controller 100 maintains the operation mode in the sleep mode (Step s1). After that, if Step s2 is executed, the electronic device 1 operates similarly thereafter.

Note that Steps s65 and s66 may be executed between Step s22 and Step s23 in the flowchart illustrated in FIG. 12 described above. In this case, if it is determined to be Yes in Step s66, Step s23 is executed. On the other hand, if it is determined to be No in Step s66, the operation mode is maintained in the lock mode (Step s21).

Further, similarly to FIG. 31, Steps s65 and s66 may be executed between Step s2 and Step s3 in the flowchart illustrated in FIG. 21 described above. Further, Steps s65 and s66 may be executed in the flowchart illustrated in FIG. 25 described above. In this case, Steps s65 and s66 are executed immediately before Step s55. If it is determined to be Yes in Step s66, Step s55 is executed.

As described above, in one example, the controller 100 performs fingerprint authentication when pressure applied on the detecting surface 201 is proper, and does not perform fingerprint authentication when the pressure is not proper. As described above, when the mean value of the detected pressures of the plurality of pressure sensors 211 is less than the second reference pressure, the controller 100 determines that the pressure applied on the detecting surface 201 is proper. Therefore, in one example, if the mean value of the detected pressures of the plurality of pressure sensors 211 is less than the second reference pressure (Yes in Step s66), it can be said that the controller 100 performs fingerprint authentication. Thus, in one example, when the pressure detection result satisfies the first condition, which is a condition in which the mean value of the plurality of detected pressures contained in the pressure detection result is less than the second reference pressure, it can be said that the controller 100 performs fingerprint authentication.

On the other hand, when the mean value of the detected pressures of the plurality of pressure sensors 211 is equal to or more than the second reference pressure, the controller 100 determines that the pressure applied on the detecting surface 201 is not proper. Therefore, in one example, if the mean value of the detected pressures of the plurality of pressure sensors 211 is equal to or more than the second reference pressure (No in Step s66), it can be said that the controller 100 does not perform fingerprint authentication. Thus, in one example, when the pressure detection result satisfies the second condition, which is a condition in which the mean value of the plurality of detected pressures contained in the pressure detection result is equal to or more than the second reference pressure, it can be said that the controller 100 does not perform fingerprint authentication.

In one example, because the fingerprint authentication is performed or the fingerprint authentication is not performed depending on the condition satisfied by the pressure detection result, convenience of the electronic device 1 is enhanced.

Further, as in one example, the configuration in which the fingerprint authentication is performed when the pressure applied on the detecting surface 201 is proper for the fingerprint authentication and in which the fingerprint authentication is not performed when the pressure applied on the detecting surface 201 is not proper for the fingerprint authentication can increase the probability that the fingerprint authentication is properly performed. Consequently, the probability of obtaining incorrect fingerprint authentication results can be reduced.

Note that, if it is determined to be No in Step s66, the controller 100 may execute processing that is similar to the processing of Step s5. In this case, for example, the controller 100 may make the display 120 display the notification information 654 and the notification information 655 on the lock screen 300 as in FIG. 30 described above.

### Fifth Another Example

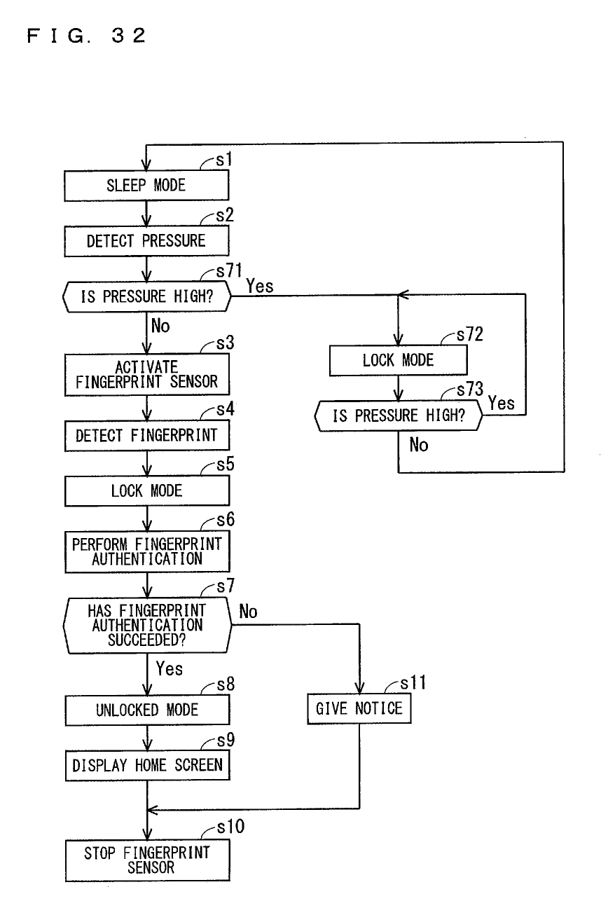

In one example, the controller 100 temporarily changes the operation mode from a sleep mode to a lock mode while the user presses hard on the detecting surface 201 with a finger. With this, the user can check the lock screen 300 while the user presses hard on the detecting surface 201 with a finger. FIG. 32 illustrates a flowchart showing one example of operation of the electronic device 1 according to one example. The flowchart illustrated in FIG. 32 is a flowchart in which Steps s71 to s73 are added to the flowchart illustrated in FIG. 9.

As illustrated in FIG. 32, after Step s2, in Step s71, the controller 100 determines whether or not pressure applied on the detecting surface 201 is high based on the pressure detection result. In Step s71, for example, when a mean value of the detected pressures of the plurality of pressure sensors 211 is equal to or more than third reference pressure, the controller 100 determines that the pressure applied on the detecting surface 201 is high. On the other hand, when the mean value of the detected pressures of the plurality of pressure sensors 211 is less than the third reference pressure, the controller 100 determines that the pressure applied on the detecting surface 201 is not high. The third reference pressure may be the same as the above-mentioned second reference pressure, or may be different.

If it is determined to be No in Step s71, the controller 100 executes Step s3 to activate the fingerprint sensor 200. The electronic device 1 operates similarly to FIG. 9 thereafter.

On the other hand, if it is determined to be Yes in Step s71, in Step s72, the controller 100 sets the operation mode to be a lock mode. Then, in Step s73, the controller 100 determines whether or not the pressure applied on the detecting surface 201 is high based on the pressure detection result, similarly to Step s71. If it is determined to be Yes in Step s73, Step s72 is executed to maintain the operation mode in the lock mode. After that, Step s73 is executed, and the electronic device 1 operates similarly thereafter. On the other hand, if it is determined to be No in Step s73, the controller 100 sets the operation mode in a sleep mode (Step s1). After that, if Step s2 is executed, the electronic device 1 operates similarly thereafter.

As described above, in one example of FIG. 32, when the operation mode is a sleep mode and the mean value of the detected pressures of the plurality of pressure sensors 211 is less than the third reference pressure, the controller 100 performs fingerprint authentication. In other words, when the display surface 121 is in a non-display state and the pressure detection result satisfies a first condition, which is a condition in which the mean value of the plurality of detected pressures contained in the pressure detection result is less than the third reference pressure, the controller 100 performs fingerprint authentication.

On the other hand, when the operation mode is a sleep mode and the mean value of the detected pressures of the plurality of pressure sensors 211 is equal to or more than the third reference pressure, the controller 100 does not perform fingerprint authentication, and sets the operation mode to be a lock mode. Then, when the mean value of the detected pressures of the pressure sensors 211 becomes less than the third reference pressure, the controller 100 sets the operation mode to a sleep mode. In other words, when the display surface 121 is in a non-display state and the pressure detection result satisfies a second condition, which is a condition in which the mean value of the plurality of detected pressures contained in the pressure detection result is equal to or more than the third reference pressure, the controller 100 does not perform fingerprint authentication, and displays the lock screen 300 on the display surface 121. Then, when the pressure detection result no longer satisfies the second condition, the controller 100 brings the display surface 121 into the non-display state. With this, the user can check the lock screen 300 while the pressure detection result satisfies the second condition. In one example, the user can check the lock screen 300 while the user presses hard on the detecting surface 201 with a finger. Consequently, convenience of the electronic device 1 is enhanced.

Note that, when the user pressing hard on the detecting surface 201 with a finger moves the finger away from the detecting surface 201, the operation mode is set to be a sleep mode, and fingerprint authentication is not performed. Further, when the user pressing hard on the detecting surface 201 with a finger presses gently on the detecting surface 201 with a finger without moving the finger away from the detecting surface 201, Step s3 and the subsequent steps are executed to perform fingerprint authentication.

Further, similarly to FIG. 32, Steps s71 to s73 may be executed in the flowchart illustrated in FIG. 21 described above. Further, Steps s71 to s73 may be executed in the flowchart illustrated in FIG. 25 described above. In this case, Step s71 is executed immediately before Step s55. If it is determined to be No in Step s71, Step s55 is executed.

### Sixth Another Example

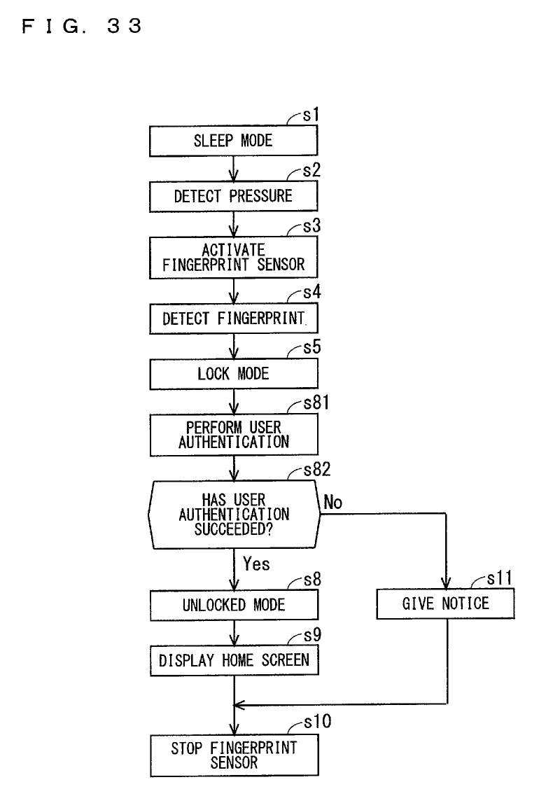

In the electronic device 1 according to one embodiment, when the detecting surface 201 is touched by a finger, the electronic device 1 performs user authentication based on a fingerprint detection result and a pressure detection result, instead of performing fingerprint authentication. FIG. 33 illustrates a flowchart showing one example of operation of the electronic device 1 according to one example. The flowchart illustrated in FIG. 33 is a flowchart in which Step s81 and Step s82 are executed instead of Step s6 and Step s7, respectively, in the flowchart illustrated in FIG. 9.

As illustrated in FIG. 33, after the execution of Step s5, in Step s81, the controller 100 performs user authentication based on the pressure detection result obtained in Step s2 and the fingerprint detection result obtained in Step s4.

In Step s81, similarly to the above-mentioned fingerprint authentication, the controller 100 compares the detected fingerprint information obtained in Step s2 and the reference fingerprint information in the storage 103. Further, based on the pressure detection result obtained in Step s2, the controller 100 determines whether or not the degree of the pressure applied on the detecting surface 201 is close to the degree of pressure (hereinafter in some cases referred to as “pressure when the authorized user performs operation”) that is supposed to be applied on the detecting surface 201 when the authorized user touches the detecting surface 201 with a finger. In Step s81, the controller 100 compares the mean value of the detected pressures of the plurality of pressure sensors 211 and fourth reference pressure in the storage 103, and calculates an absolute value of a difference between the mean value and the fourth reference pressure. Then, when the calculated absolute value is equal to or less than a threshold value, the controller 100 determines that the degree of the pressure applied on the detecting surface 201 is close to the degree of pressure when the authorized user performs operation. On the other hand, when the calculated absolute value is more than the threshold value, the controller 100 determines that the degree of the pressure applied on the detecting surface 201 is not close to the degree of pressure when the authorized user performs operation.

The fourth reference pressure is set based on a pressure detection result, for example, similarly to the above-mentioned second reference pressure. For example, when the operation mode is a fingerprint registration mode, the controller 100 may set the fourth reference pressure based on the pressure detection result obtained when the reference fingerprint information is registered in the electronic device 1. Similarly to the case where the second reference pressure is set, when the operation mode is a fingerprint registration mode, the controller 100 calculates a mean value of the detected pressures of the plurality of pressure sensors 211 as a primary mean value every time the detecting surface 201 is touched. With this, when the user touches the detecting surface 201 a plurality of times when the operation mode is a fingerprint registration mode, a plurality of primary mean values can be obtained. The controller 100 calculates a mean value of the obtained plurality of primary mean values as a secondary mean value. The controller 100 sets the fourth reference pressure based on the calculated secondary mean value. For example, the controller 100 uses a value that is equal to the secondary mean value as the fourth reference pressure. Note that a method of setting the fourth reference pressure is not limited to the above.

In Step s81, when the detected fingerprint information and the reference fingerprint information in the storage 103 are similar to each other, and the degree of the pressure applied on the detecting surface 201 is close to the degree of pressure when the authorized user performs operation, the controller 100 determines that the user authentication has succeeded. Specifically, the controller 100 determines that the user who has the finger touching the detecting surface 201 is the authorized user. On the other hand, when the detected fingerprint information and the reference fingerprint information in the storage 103 are not similar to each other, the controller 100 determines that the user authentication has failed. Specifically, the controller 100 determines that the user who has the finger touching the detecting surface 201 is an unauthorized user. Further, when the degree of the pressure applied on the detecting surface 201 is not close to the degree of pressure when the authorized user performs operation, the controller 100 determines that the user authentication has failed.

If the user authentication of Step s81 succeeds (Yes in Step s82), the controller 100 executes Step s8 to set the operation mode to be an unlocked mode. The electronic device 1 operates similarly thereafter. On the other hand, if the user authentication of Step s81 fails (No in Step s82), the controller 100 executes Step s11 to make the display 120 display the failure notification information 650. After that, Step s10 is executed, and the fingerprint sensor 200 stops.

In one example, because user authentication based on a fingerprint detection result and a pressure detection result is performed, whether or not the user touching the detecting surface 201 is the authorized user can be more properly determined. Consequently, security of the electronic device 1 can be enhanced.

Note that Step s81 and Step s82 may be executed instead of Step s25 and Step s26, respectively, in the flowchart illustrated in FIG. 12 described above. Further, Step s81 and Step s82 may be executed instead of Step s6 and Step s7, respectively, in the flowcharts illustrated in FIG. 21 and FIG. 25 described above.

Further, in one example, in Step s81, user authentication based on a fingerprint detection result and a pressure detection result is performed. However, user authentication based only on a pressure detection result among the fingerprint detection result and the pressure detection result may be performed. In this case, in Step s81, if the controller 100 determines that the degree of the pressure applied on the detecting surface 201 is close to the degree of pressure when the authorized user performs operation, the controller 100 determines that the user authentication has succeeded. On the other hand, when the controller 100 determines that the degree of the pressure applied on the detecting surface 201 is not close to the degree of pressure when the authorized user performs operation, the controller 100 determines that the user authentication has failed.

### Seventh Another Example

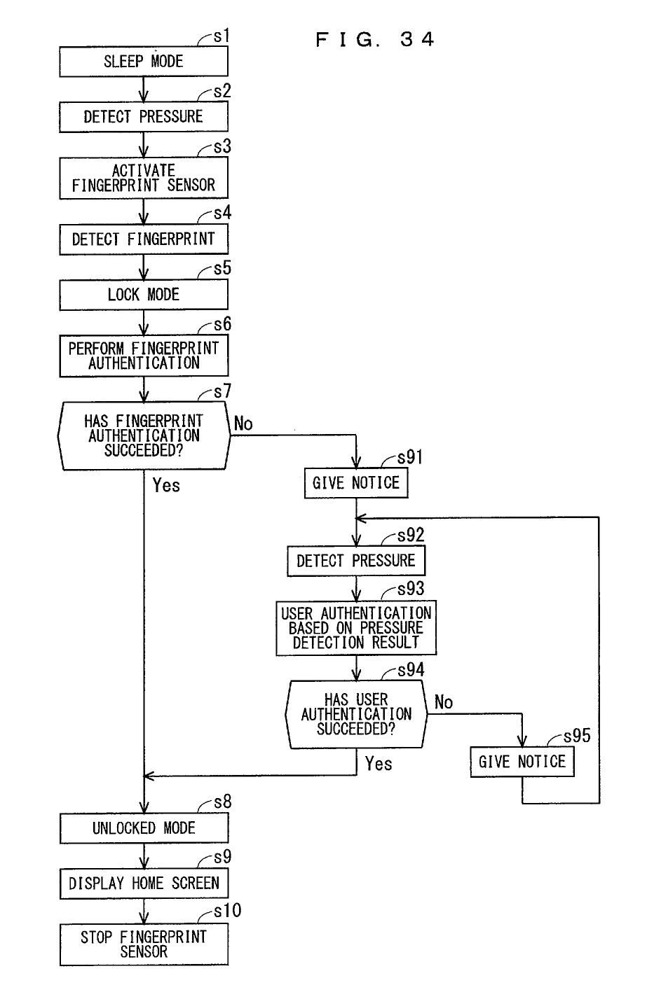

When the electronic device 1 according to one example fails in fingerprint authentication, the electronic device 1 performs user authentication based on a pressure detection result that is obtained after performing the fingerprint authentication. FIG. 34 illustrates a flowchart showing one example of operation of the electronic device 1 according to one example. The flowchart illustrated in FIG. 34 is a flowchart in which Steps s91 to s95 are executed instead of Step s11 in the flowchart illustrated in FIG. 9.

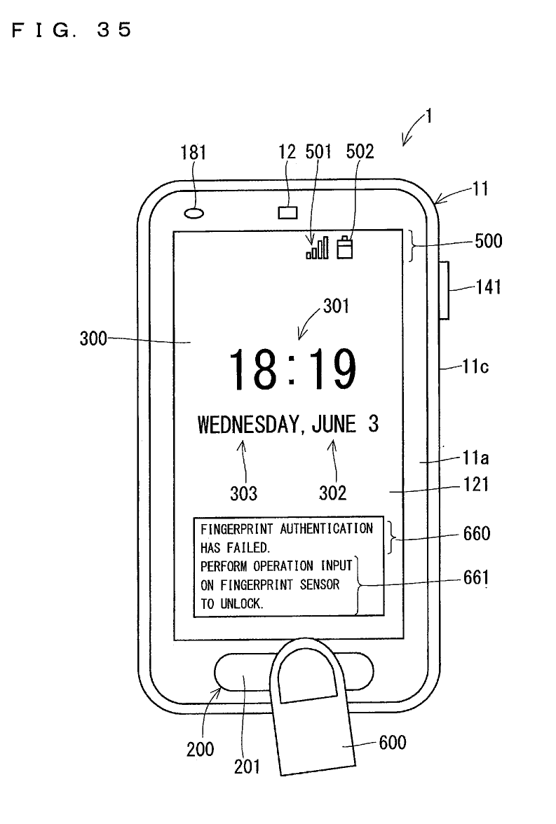

If it is determined in Step s7 that the fingerprint authentication has failed, in Step s91, the controller 100 makes the display 120 display failure notification information 660 that gives notice that the fingerprint authentication has failed, and operation instruction information 661 that instructs the user to perform operation for user authentication on the detecting surface 201. FIG. 35 illustrates a diagram showing one example of the failure notification information 660 and the operation instruction information 661.

After Step s91, if the controller 100 determines that the pressure detector 210 has detected pressure based on a pressure detection result in Step s92, the controller 100 executes Step s93. If at least one of the plurality of pressure sensors 211 detects pressure, the controller 100 executes Step s93.

In Step s93, the controller 100 performs user authentication based on the pressure detection result obtained in Step s92. In one example, the controller 100 specifies operation on the detecting surface 201 based on the pressure detection result. Then, when the specified operation matches reference operation that is registered in the storage 103, the controller 100 determines that the user authentication based on the pressure detection result has succeeded. On the other hand, when the specified operation does not match the reference operation that is registered in the storage 103, the controller 100 determines that the user authentication based on the pressure detection result has failed.

Here, the normal mode comprises an operation registration mode for registering operation performed on the detecting surface 201 by the user in the electronic device 1 as reference operation. When predetermined operation is performed on the display surface 121 during an unlocked mode, the electronic device 1 operates in the operation registration mode. When the authorized user performs predetermined operation on the detecting surface 201 during the operation registration mode, the controller 100 specifies the predetermined operation based on the pressure detection result, and registers the specified predetermined operation in the storage 103 as the reference operation.

As the reference operation, various operations are conceivable. For example, the reference operation may be operation in which a predetermined portion (e.g., the upper left portion 201a) of the detecting surface 201 is consecutively pressed hard a plurality of times by a finger. Alternatively, the reference operation may be operation in which a finger moves from left to right on the detecting surface 201, and the finger subsequently moves from right to left.

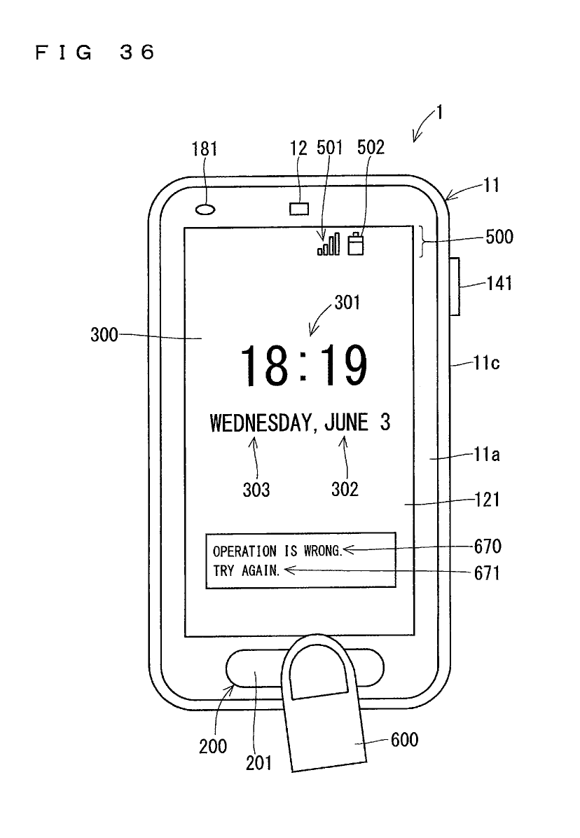

If the user authentication of Step s93 succeeds (Yes in Step s94), Step s8 is executed, and the electronic device 1 operates similarly thereafter. On the other hand, if the user authentication of Step s93 fails (No in Step s94), in Step s95, the controller 100 makes the display 120 display failure notification information 670 that gives notice that the user authentication based on the pressure detection result has failed. FIG. 36 illustrates a diagram showing a display example of the failure notification information 670. In one example, as illustrated in FIG. 36, the controller 100 makes the display 120 display re-execution instruction information 671 that instructs the user to perform operation for user authentication again on the detecting surface 201, in addition to displaying the failure notification information 670.

After Step s95, if the pressure detector 210 detects pressure again (Step s92), the controller 100 executes Step s93 again. The electronic device 1 operates similarly thereafter.

In this manner, in one example, when fingerprint authentication fails, the controller 100 performs user authentication based on a pressure detection result that is obtained after performing the fingerprint authentication. Therefore, even when the authorized user fails in fingerprint authentication, the authorized user can make the electronic device 1 perform user authentication based on the pressure detection result by touching the detecting surface 201. Consequently, convenience of the electronic device 1 is enhanced.

Note that a plurality of types of reference operations may be registered in the storage 103. In this case, in Step s93, when the plurality of types of reference operations comprise operation that matches the operation specified based on the pressure detection result, the controller 100 determines that the user authentication based on the pressure detection result has succeeded. On the other hand, when the plurality of types of reference operations do not comprise operation that matches the operation specified based on the pressure detection result, the controller 100 determines that the user authentication based on the pressure detection result has failed.

Further, Steps s91 to s95 may be executed instead of Step s30 in the flowchart illustrated in FIG. 12. In this case, if it is determined to be Yes in Step s94, Step s27 is executed. Further, similarly to FIG. 34, Steps s91 to s95 may be executed instead of Step s11 in the flowchart illustrated in FIG. 25 described above.

### Eighth Another Example

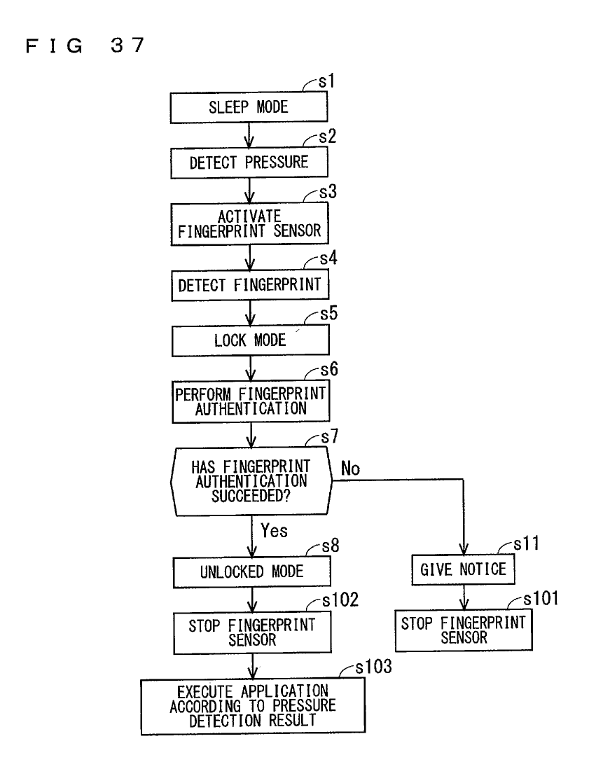

When fingerprint authentication succeeds, the electronic device 1 according to one example can execute an application according to a pressure detection result that is obtained when the fingerprint authentication is performed. FIG. 37 illustrates a flowchart showing one example of operation of the electronic device 1 according to one example. The flowchart illustrated in FIG. 37 is a flowchart in which Steps s101 to s103 are executed instead of Steps s9 and s10 in the flowchart illustrated in FIG. 9.

As illustrated in FIG. 37, after the execution of Step s11, the controller 100 stops the fingerprint sensor 200 in Step s101. Further, after the execution of Step s8, the controller 100 stops the fingerprint sensor 200 in Step s102. After that, in Step s103, the controller 100 executes an application according to the pressure detection result obtained in Step s2. In Step s103, the controller 100 specifies operation on the detecting surface 201 based on the pressure detection result obtained in Step s2. Then, the controller 100 executes an application according to the specified operation.

In one example, operation on the detecting surface 201 and an application to be executed when it is determined in Step s101 that the operation is performed are associated with each other. The association relationship between the operation on the detecting surface 201 and the application are stored in the storage 103. In one example, for example, operation in which a left portion of the detecting surface 201 is touched by a finger and the first application (e.g., a camera application) in the storage 103 are associated with each other. Further, operation in which a right portion of the detecting surface 201 is touched by a finger and the second application (a web browser) in the storage 103 are associated with each other.

In Step s103, when the detected pressure of the pressure sensor 211a is higher than the detected pressure of the pressure sensor 211c, the controller 100 determines that the operation in which a left portion of the detecting surface 201 is touched by a finger has been performed. Also, when the detected pressure of the pressure sensor 211b is higher than the detected pressure of the pressure sensor 211d, the controller 100 determines that the operation in which a left portion of the detecting surface 201 is touched by a finger has been performed. In Step s103, when the specified operation is the operation in which a left portion of the detecting surface 201 is touched by a finger, the controller 100 executes the first application in the storage 103.

On the other hand, when the detected pressure of the pressure sensor 211c is higher than the detected pressure of the pressure sensor 211a, the controller 100 determines that the operation in which a right portion of the detecting surface 201 is touched by a finger has been performed. Also, when the detected pressure of the pressure sensor 211d is higher than the detected pressure of the pressure sensor 211b, the controller 100 determines that the operation in which a right portion of the detecting surface 201 is touched by a finger has been performed. In Step s103, when the specified operation is the operation in which a right portion of the detecting surface 201 is touched by a finger, the controller 100 executes the second application in the storage 103.

After the execution of Step s102, the display surface 121 displays a screen according to the executed application.

Note that Steps s101 to s103 may be executed instead of Steps s28 and s29 in the flowchart illustrated in FIG. 12. In this case, Step s101 is executed after Step s30, and Steps s102 and s103 are executed after Step s27. Further, Steps s101 to s103 may be executed instead of Steps s9 and s10 in the flowchart illustrated in FIG. 21. In this case, Step s101 is executed after Step s52, and Steps s102 and s103 are executed after Step s8. Further, similarly to FIG. 37, Steps s101 to s103 may be executed instead of Steps s9 and s10 in the flowcharts illustrated in FIG. 25, FIG. 29, FIG. 31, FIG. 32, and

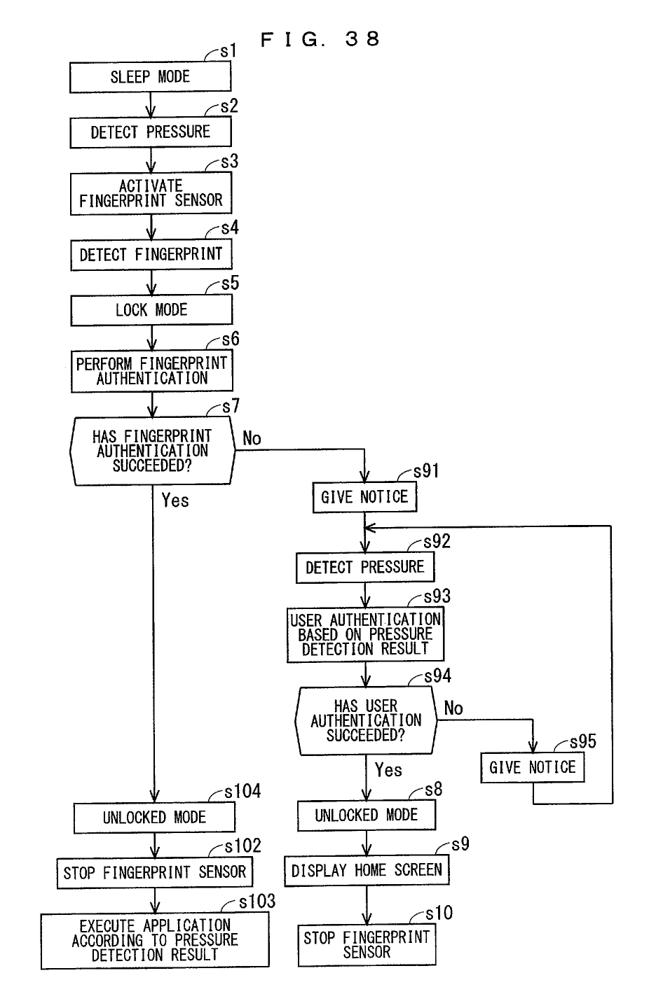

FIG. 33. Further, Steps s101 to s103 may be executed instead of Steps s9 and s10 in the flowchart illustrated in FIG. 27. In this case, Step s101 is executed after Steps s11 and s63, and Steps s102 and s103 are executed after Step s8. Further, as illustrated in FIG. 38, if it is determined to be Yes in Step s7 in the flowchart illustrated in FIG. 34, Steps s8 to s10 may not be executed, and the operation mode may be set to be an unlocked mode in Step s104, and subsequently Steps s102 and s103 may be executed.

Further, the association relationship between the operation on the detecting surface 201 and the application to be executed when it is determined in Step s101 that the operation is performed is not limited to the above.

In this manner, in one example, when fingerprint authentication succeeds, the controller 100 executes an application according to a pressure detection result that is obtained when the fingerprint authentication is performed. Therefore, the user can make the electronic device 1 execute an application according to operation performed on the detecting surface 201 when the user makes the electronic device 1 perform the fingerprint authentication. Consequently, convenience of the electronic device 1 is enhanced.

In one example, the electronic device 1 is a mobile phone such as a smartphone, but may be an electronic device of other types. The electronic device 1 may be, for example, a tablet terminal, a personal computer, a wearable device, or the like. The wearable device that can be adopted as the electronic device 1 may be of an arm-worn type such as a wristband type or a wristwatch type, a head-worn type such as a headband type or an eyeglass type, or a body-worn type such as a clothing type.

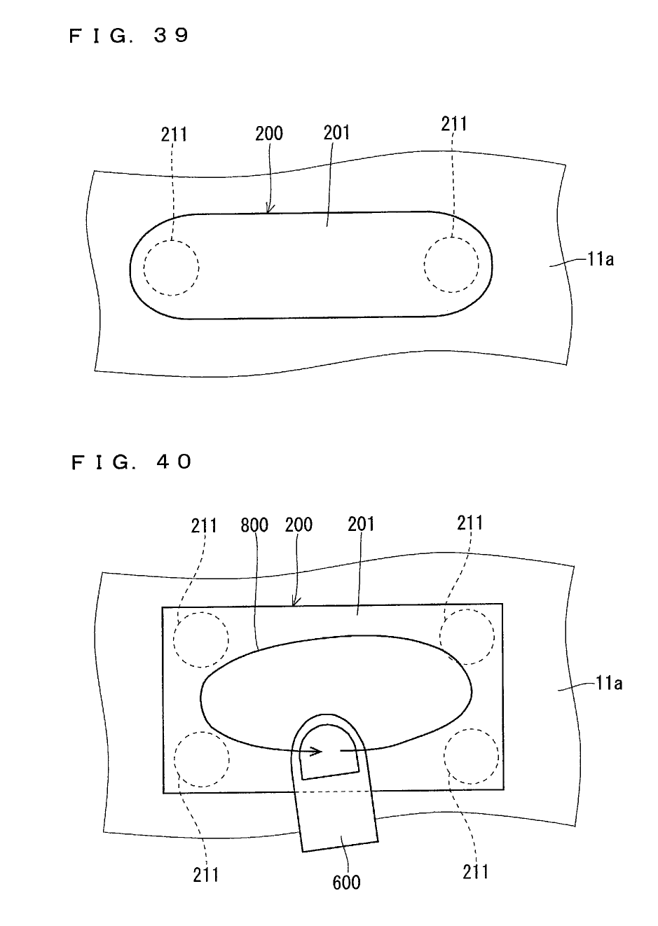

While the electronic device 1 has been described in detail, the foregoing description is in all aspects illustrative and not restrictive. For example, at least one of the number and the disposition of the pressure sensors 211, and the shape of the detecting surface 201 may be different from the foregoing examples. For example, as illustrated in FIG. 39, the number of the pressure sensors 211 may be two. In one example of FIG. 39, two pressure sensors 211 are located so as to overlap respective left end portion and right end portion of the detecting surface 201 when the two pressure sensors 211 are seen through in plan view from the front surface 11a of the device case 11.

Further, as illustrated in FIG. 40, the shape of the detecting surface 201 may be a quadrilateral. In one example of FIG. 40, four pressure sensors 211 are located so as to overlap respective upper left corner portion, lower left corner portion, upper right corner portion, and lower right corner portion of the detecting surface 201 when the four pressure sensors 211 are seen through in plan view from the front surface 11a of the device case 11. In one example of FIG. 40, the controller 100 can even specify operation as indicated by an arrow 800 in which the finger 600 moves on the detecting surface 201 in a manner of drawing a circle based on the detected pressures of the four pressure sensors 211.

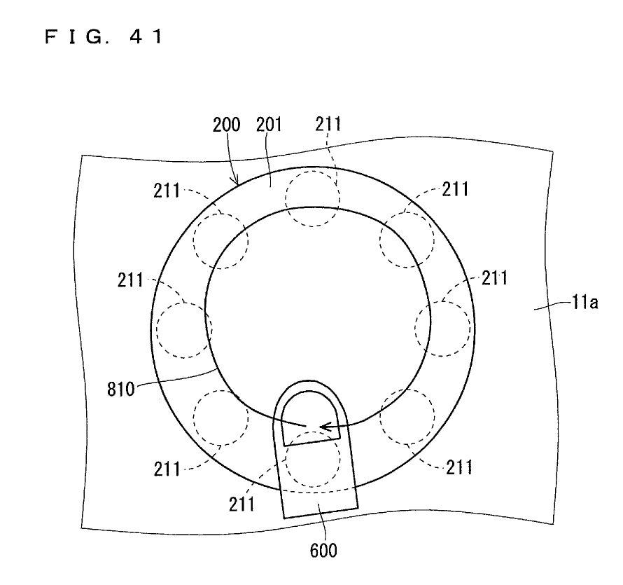

Further, as illustrated in FIG. 41, the shape of the detecting surface 201 may be a circle. In one example of FIG. 41, eight pressure sensors 211 are located along a peripheral edge portion of the detecting surface 201 so as to overlap the peripheral edge portion when the eight pressure sensors 211 are seen through in plan view from the front surface 11a of the device case 11. In one example of FIG. 41, similarly to one example of FIG. 40 described above, the controller 100 can even specify operation as indicated by an arrow 810 in which the finger 600 moves on the detecting surface 201 in a manner of drawing a circle based on the detected pressures of the eight pressure sensors 211.

Further, various examples described above can be applied in combination on the condition that the combination be consistent. It is therefore understood that numerous unillustrated examples can be devised without departing from the scope of the present disclosure.

1. An electronic device comprising:
a fingerprint sensor comprising a detecting surface, and being configured to detect a fingerprint of a finger touching the detecting surface;
a pressure detector comprising a plurality of pressure sensors configured to detect pressure applied on the detecting surface; and
at least one processor configured to perform processing based on a fingerprint detection result of the fingerprint sensor and a pressure detection result of the pressure detector, wherein
the pressure detection result varies depending on a position on the detecting surface at which the pressure is applied.

2. The electronic device according to claim 1, wherein
the at least one processor activates the fingerprint sensor in accordance with detection of the pressure in the pressure detector.

3. The electronic device according to claim 1, wherein
the at least one processor specifies operation on the detecting surface based on the pressure detection result, and performs processing according to the specified operation.

4. The electronic device according to claim 3, wherein
the at least one processor specifies at least one of speed, a direction, and intensity of the operation based on the pressure detection result.

5. The electronic device according to claim 3, wherein
the at least one processor executes an application program according to the operation.

6. The electronic device according to claim 1, further comprising:
a display comprising a display surface configured to display information; and
a sensor configured to detect operation input on the display surface, wherein
the at least one processor performs processing according to the operation input, and
the at least one processor invalidates the operation input on at least a part of the display surface while the pressure detector detects the pressure.

7. The electronic device according to claim 6, wherein
the display surface comprises a first portion and a second portion, the second portion being located at a position closer to the detecting surface than the first portion, wherein
the operation input on the first portion is not invalidated while the pressure detector detects the pressure, and
the operation input on the second portion is invalidated while the pressure detector detects the pressure.

8. The electronic device according to claim 6, wherein
the at least one processor performs user authentication based on the fingerprint detection result, and
the at least one processor invalidates the operation input on the at least a part of the display surface while the user authentication is performed and the pressure detector detects the pressure.

9. The electronic device according to claim 1, wherein
the at least one processor performs first user authentication based on the fingerprint detection result.

10. The electronic device according to claim 9, further comprising
a notification unit configured to give notice to a user.

11. The electronic device according to claim 10, wherein
when the at least one processor performs the first user authentication, the at least one processor specifies deviation of a position of the finger on the detecting surface with respect to a reference position based on the pressure detection result, and notifies the notification unit of the deviation.

12. The electronic device according to claim 11, wherein
when the notification unit gives notice of the deviation, the notification unit gives notice of guide information that guides change of the position.

13. The electronic device according to claim 10, wherein
when the at least one processor performs the first user authentication, the at least one processor performs determining processing for determining whether or not the pressure is proper for the first user authentication based on the pressure detection result, and
when the at least one processor determines that the pressure is not proper in the determining processing, the at least one processor makes the notification unit give notice that the pressure is not proper.

14. The electronic device according to claim 13, wherein
the at least one processor registers fingerprint information obtained in the fingerprint sensor in the electronic device as reference fingerprint information to be used in the first user authentication, and
the at least one processor sets reference pressure to be used in the determining processing based on the pressure detection result obtained when the reference fingerprint information is registered.

15. The electronic device according to claim 9, wherein
when the pressure detection result satisfies a first condition, the at least one processor performs the first user authentication, and
when the pressure detection result satisfies a second condition, the at least one processor does not perform the first user authentication.

16. The electronic device according to claim 15, further comprising
a display comprising a display surface configured to display information, wherein
when the display surface is in a non-display state and the pressure detection result satisfies the first condition, the at least one processor performs the first user authentication, and
when the display surface is in a non-display state and the pressure detection result satisfies the second condition, the at least one processor does not perform the first user authentication, and displays a predetermined screen on the display surface, and then when the pressure detection result no longer satisfies the second condition, the at least one processor brings the display surface into the non-display state.

17. The electronic device according to claim 9, wherein
the at least one processor performs the first user authentication based on the fingerprint detection result and the pressure detection result.

18. The electronic device according to claim 9, wherein
when the first user authentication succeeds, the at least one processor executes an application program according to the pressure detection result obtained when the first user authentication is executed.

19. A controller comprised in an electronic device, the electronic device comprising:
a fingerprint sensor comprising a detecting surface, and being configured to detect a fingerprint of a finger touching the detecting surface; and
a pressure detector comprising a plurality of pressure sensors configured to detect pressure applied on the detecting surface, wherein
a pressure detection result of the pressure detector varies depending on a position on the detecting surface at which the pressure is applied,
the controller being configured to perform processing based on a fingerprint detection result of the fingerprint sensor and the pressure detection result.

20. An operation method of an electronic device, the electronic device comprising:
a fingerprint sensor comprising a detecting surface, and being configured to detect a fingerprint of a finger touching the detecting surface; and
a pressure detector comprising a plurality of pressure sensors configured to detect pressure applied on the detecting surface, wherein
a pressure detection result of the pressure detector varies depending on a position on the detecting surface at which the pressure is applied,
the operation method comprising performing processing based on a fingerprint detection result of the fingerprint sensor and the pressure detection result.
